(19) United States
(12) Patent Application Publication
(10) Pub. No.: US 2025/0346835 A1
(43) Pub. Date: Nov. 13, 2025

(54) DETERGENT AND CLEANING AGENT WITH IMPROVED ENZYME STABILITY

(71) Applicant: Henkel AG & Co. KGaA, Düsseldorf (DE)

(72) Inventors: Shoana Islam, Düsseldorf (DE); Christian Degering, Erkrath (DE); Susanne Wieland, Dormagen (Zons) (DE); Ayhan Aydemir, Düsseldorf (DE); Claudia Lindner, Solingen (DE); Sven Benson, Stuttgart (DE); Philipp Schellenberger, Remshalden (DE); Lenz Lorenz, Sindelfingen (DE)

(21) Appl. No.: 18/870,818

(22) PCT Filed: May 24, 2023
(86) PCT No.: PCT/DE2023/100388

§ 371 Date: Dec. 2, 2024

(30) Foreign Application Priority Data
Jun. 1, 2022 (DE) 10 2022 205 593.4

(51) Int. Cl. C11D 7/40

(52) U.S. Cl. CPC C11D 7/40

(57) ABSTRACT

The invention relates to washing and cleaning agents, in particular, liquid washing and cleaning agents, and particularly preferably liquid textile washing agents, comprising a) at least one protease, preferably in an amount of 0.0001 to 1 wt. %, relative to the total weight of the washing and cleaning agent, b) at least one peptide (peptidic inhibitor), preferably in a 0.5-, 1.0-, 1.5-, 2.0-, 2.5-, 3.0-, 3.5-, 4.0-, 4.5-, 5.0-, 10-, 15-, 18-, 20-, 25-, 27-, or 30-fold molar excess relative to the molarity of the protease used, preferably in a 15-, 18-, 20-, 25-, or 27-fold molar excess, the peptide preferably having a length of 50 to 200, preferably 55 to 190, and more preferably 60 to 180, amino acid functional groups, and c) at least one washing and cleaning agent ingredient, preferably in an amount of 0.01 to 99.9 wt. %, relative to the total weight of the washing and cleaning agent. Also included in the invention are the corresponding washing and cleaning processes, the use of the agents described herein, and the use of a peptidic inhibitor to improve the stability of a protease in washing or cleaning agents.

The invention is in the field of enzyme technology. The invention relates to washing or cleaning agents comprising at least one protease and at least one peptidic inhibitor. Also included in the invention are the corresponding washing and cleaning processes, the use of the agents described herein, and the use of a peptidic inhibitor to improve the stability of a protease in washing or cleaning agents.

The use of enzymes in washing agents has been established in the prior art for decades. They are used to expand the performance range of the agents in question according to their special activities. These include in particular hydrolytic enzymes such as proteases, amylases, lipases, and cellulases. The first three mentioned hydrolyze proteins, starch, and fats and thus contribute directly to the removal of dirt. Cellulases are used in particular due to their effect on fabric. Another group of washing agent enzymes are oxidative enzymes, in particular oxidases, which, optionally in conjunction with other components, are preferably used to bleach stains or to produce the bleaching agents in situ. In addition to these enzymes, which are subject to continuous optimization, other enzymes are constantly being made available for use in washing agents in particular in order to be able to optimally tackle specific stains, such as pectinases, 0-glucanases, mannanases, or other hemicellulases (glycosidases) to hydrolyze specific vegetable polymers in particular.

Proteases are among the technically most important enzymes. For washing and cleaning agents, they are the longest established enzymes and are contained in virtually all modern, high-performance washing and cleaning agents. In washing and cleaning agents, proteases are used to break down protein-containing stains on the items to be cleaned. However, they also hydrolyze themselves (autoproteolysis) and all other proteins contained in the agents in question, i.e., in particular other enzymes contained in the washing and cleaning agents. This occurs particularly during the cleaning process, i.e., in the aqueous washing or cleaning liquor, when comparatively favorable reaction conditions are present. To a lesser extent, however, this also occurs during storage of the agent in question, which is why long storage periods are always accompanied by a certain loss of protease activity and the activities of the other enzymes. As a result of the loss of enzymatic activity, the enzymes no longer demonstrate optimal cleaning performance. This is particularly problematic in gel or liquid and in particular in water-containing formulations, because in this form both the reaction medium and the hydrolysis reagent are provided with the water contained.

In general, only selected proteases are suitable for use in liquid, surfactant-containing preparations in any case. Many proteases do not exhibit sufficient catalytic performance in such preparations, or they are not sufficiently stable. For the use of proteases in cleaning agents, therefore, a high catalytic activity and stability under conditions as they are during a wash cycle is particularly desirable. Examples of subtilisin-type proteases that are preferably used in washing and cleaning agents are the subtilisins BPN′ from Bacillus amyloliquefaciens and Carlsberg from Bacillus licheniformis, protease PB92, subtilisins 147 and 309, the protease from Bacillus lentus, in particular Bacillus lentus DSM 5483, subtilisin DY and the enzymes thermitase, proteinase K, and proteases TW3 and TW7, which are to be classified as subtilases, but no longer as subtilisins in the narrower sense, as well as variants of said proteases that have an amino acid sequence which is modified with respect to the starting protease. Proteases are altered in a targeted or random manner by methods known from the prior art and are thus optimized for use in washing and cleaning agents, for example. This includes point, deletion or insertion mutagenesis, or fusion with other proteins or protein parts. Thus, appropriately optimized variants are known for most proteases known from the prior art. European patent application EP 2016175 A1, for example, discloses a protease from Bacillus pumilus provided for washing and cleaning agents.

One goal in the development of washing and cleaning agent formulations is therefore that of stabilizing the enzymes contained, in particular during storage, and also to prevent them from denaturing and/or cleaving or breaking down and/or decomposing due to physical influences or oxidation, etc., in particular during the storage and/or use of the washing or cleaning agent. One focus of these developments is that of protecting the proteins and/or enzymes contained from (auto)proteolytic cleavage. This can be done by building up physical barriers—for example, by encapsulating the enzymes in specific enzyme granules or by packaging the agents in two-chamber or multi-chamber systems. The other way, which is frequently used, consists in adding chemical compounds which inhibit the proteases and thus act in general as stabilizers for proteases and the other proteins and enzymes contained. However, these must be reversible protease inhibitors, since the protease activity is to be prevented only temporarily, in particular during storage, but not during the cleaning process.

The prior art describes various reversible protease inhibitors, e.g., polyols, in particular glycerol and 1,2-propylene glycol, benzamidine hydrochloride, borax, boric acids, boronic acids, or the salts or esters thereof. Using boric acid derivatives together with polyols is also known. 4-formylphenylboronic acid (4-FPBA) is also a protease inhibitor known from the prior art. Peptide aldehydes, i.e., oligopeptides having a reduced C-terminus, in particular those consisting of 2 to 50 monomers, are also described for this purpose. The reversible peptide protease inhibitors include, inter alia, ovomucoid and leupeptin. Specific, reversible peptide inhibitors and fusion proteins from proteases and specific peptide inhibitors are also used for this purpose.

However, there is still a need to improve the cleaning performance of enzyme-containing washing and cleaning agents and to better stabilize the enzymes contained in the washing and cleaning agents. In particular, there is an increasing requirement to dispense with boric acid-containing compounds, i.e., in particular boron-containing protease inhibitors, in washing and cleaning agents.

Surprisingly, it has now been found that certain peptidic inhibitors can advantageously stabilize and reversibly inhibit a protease and are therefore particularly suitable for use in washing or cleaning agents. In particular, it was surprisingly found that a protease from Bacillus pumilus comprising an amino acid sequence which is at least 70% identical to the amino acid sequence given in SEQ ID NO:1 over its entire length, and, in each case based upon the numbering according to SEQ ID NO:1 (i) at the positions corresponding to positions 9, 130, 133, 144, 217, 252, and 271, the amino acid substitutions 9T, 130D, 133A, 144K, 217M, 252T, and 271E, and (ii) at at least one, preferably two, and more preferably three, of the positions corresponding to positions 6, 89, 131, 166, 187, 189, 211, or 224, at least one further amino acid substitution, which is selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, can be advantageously stabilized by certain peptidic inhibitors, and this combination is therefore particularly suitable for use in washing or cleaning agents.

The object of the invention is therefore, in a first aspect, a washing and cleaning agent, in particular a liquid washing and cleaning agent, and particularly preferably a liquid textile washing agent, comprising
a) at least one protease, preferably in an amount of 0.0001 to 1 wt. %, relative to the total weight of the washing and cleaning agent,
b) at least one peptide, preferably in a 0.5-, 1.0-, 1.5-, 2.0-, 2.5-, 3.0-, 3.5-, 4.0-, 4.5-, 5.0-, 10-, 15-, 18-, 20-, 25-, 27-, or 30-fold molar excess relative to the molarity of the protease used, the peptide preferably having a length of 50 to 200, preferably 55 to 190, and more preferably 60 to 180, amino acid functional groups, and
c) at least one washing and cleaning agent ingredient, preferably in an amount of 0.01 to 99.9 wt. %, relative to the total weight of the washing and cleaning agent.

A further object of the invention is a washing and cleaning agent, in particular a liquid washing and cleaning agent, and particularly preferably a liquid textile washing agent, comprising
a) at least one protease, preferably in an amount of 0.0001 to 1 wt. %, relative to the total weight of the washing and cleaning agent, the protease having proteolytic activity and comprising an amino acid sequence which is at least 70% identical to the amino acid sequence given in SEQ ID NO:1 over its entire length, and, in each case based upon the numbering according to SEQ ID NO:1 (i) at the positions corresponding to positions 9, 130, 133, 144, 217, 252, and 271, the amino acid substitutions 9T, 130D, 133A, 144K, 217M, 252T, and 271E, and (ii) at at least one, preferably two, and more preferably three, of the positions corresponding to positions 6, 89, 131, 166, 187, 189, 211, or 224, at least one further amino acid substitution, which is selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) at least one peptide, preferably in a 0.5-, 1.0-, 1.5-, 2.0-, 2.5-, 3.0-, 3.5-, 4.0-, 4.5-, 5.0-, 10-, 15-, 18-, 20-, 25-, 27-, or 30-fold molar excess relative to the molarity of the protease used, the peptide preferably having a length of 50 to 200, preferably 55 to 190, and more preferably 60 to 180, amino acid functional groups, the peptide having an amino acid sequence which is at least 90% identical, over its entire length, to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably SEQ ID NO:2, SEQ ID NO:4, SEQ ID NO:5, SEQ ID NO:8, or SEQ ID NO:11.
c) at least one washing and cleaning agent ingredient, preferably in an amount of 0.01 to 99.9 wt. %, relative to the total weight of the washing and cleaning agent.

Further aspects of the invention relate to processes for the preparation of such a washing or cleaning agent, processes for cleaning textiles and/or hard surfaces, in particular dishes, using an agent according to the invention.

A further object of the invention relates to the use of a peptide defined herein (peptidic inhibitor) for improving the stability, in particular the storage stability, of proteases, in particular of proteases defined herein from Bacillus pumilus, in a washing and cleaning agent, preferably in a temperature range of about 20° C. to about 60° C., particularly preferably of about 20° C. to about 40° C., and most preferably at about 30° C., and the use of a peptide defined herein for preventing and/or reducing the autoproteolysis of a protease contained in the washing and cleaning agent, particularly a protease from Bacillus pumilus defined herein.

The washing agent according to the invention is preferably a liquid textile washing agent. More preferably, the textile washing agent according to the invention has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

Textile washing agents according to the invention also demonstrate performance advantages over other textile washing agents in particular when the textile washing agents contain at least one additional enzyme of the same or a different type, e.g., amylase, cellulase, lipase, mannanase, or pectinase, the list of other enzymes being incomplete. It is therefore preferred that the textile washing agents according to the invention contain at least one additional enzyme of the same type (i.e., an additional protease) or of a different type.

These and other aspects, features and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate but not to limit the invention and that, in particular, the invention is not limited to these examples.

Unless indicated otherwise, all percentages are indicated in terms of weight percent (wt. %).

Numerical ranges that are indicated in the format “from x to y” also include the stated values. If several preferred numerical ranges are specified in this format, it is readily understood that any ranges resulting from the combination of the various endpoints are also included.

“At least one,” as used herein, means one or more, i.e., 1, 2, 3, 4, 5, 6, 7, 8, 9, 10, 11, 12, 13, 14 or more.

The term “washing and cleaning agent” or “washing or cleaning agent,” as used herein, is synonymous with the term “agent” and denotes a composition for cleaning textiles and/or hard surfaces, in particular dishes, as explained in the description.

“Approximately,” “about,” or “roughly,” as used herein in reference to a numerical value, refers to the corresponding numerical value ±10%, preferably ±5%.

“Substantially free of” means that the composition or the agent contains less than 2 wt. %, preferably less than 1 wt. %, more preferably less than 0.5 wt. %, and particularly preferably less than 0.1 wt. %, of the corresponding substance, relative to the total weight of the composition/agent.

“Liquid,” as used herein, includes liquids and gels as well as pasty compositions. It is preferred that the liquid compositions be flowable and pourable at room temperature, but it is also possible for them to have a limit of liquidity. A substance, e.g., a composition or an agent, is solid according to the definition of the invention if it is in a solid state of aggregation at 25° C. and 1,013 mbar. A substance, e.g., a composition or an agent, is liquid according to the definition of the invention if it is in a liquid state of aggregation at 25° C. and 1,013 mbar. Liquid also includes gel form.

“Variant,” as used herein, refers to naturally or artificially generated variations of a native protease which has an amino acid sequence which is modified from the reference form.

The specification “in a 0.5-fold molar excess of a raw material relative to the molarity of the protease used” means that the number of particles of the raw material present in the composition or the agent corresponds exactly to half the number of particles of the protease present in the composition or the agent. Accordingly, the specification “in a 2.0-fold molar excess of a raw material relative to the molarity of the protease used” means that twice the number of raw material particles are present compared to protease particles.

“Improving the stability of an enzyme” within the meaning of the invention occurs when the presence of a peptidic inhibitor causes a washing or cleaning agent comprising at least one protease and at least one peptidic inhibitor (washing or cleaning agent according to the invention) to have a higher enzymatic activity of the protease and/or optionally further enzymes contained in the washing or cleaning agent after storage compared to a control preparation which differs from the washing or cleaning agent according to the invention only due to the absence of the stabilizer compound (control). After storage, the washing or cleaning agent according to the invention therefore has a higher residual activity of the contained protease and/or optionally further contained enzymes compared to the control, with the washing or cleaning agent according to the invention and the control having the same initial enzymatic activity at the start of storage and both agents being treated in the same way, in particular with regard to the storage conditions and the determination of the enzyme activity. Increasingly preferably, storage takes place for at least 1 week, 2 weeks, 3 weeks, or 4 weeks, More preferably, storage takes place at a temperature of 20° C., 25° C., 30° C., or 40° C.

The present invention is based upon the surprising finding by the inventors that the peptidic inhibitors described herein bring about improved storage stability of proteases in washing and cleaning agents. This is particularly surprising, since these peptic inhibitors have not previously been associated with reversible protease inhibition. In particular, they have not yet been associated with the proteases from Bacillus pumilus described herein and improved storage stability and/or reduced autoproteolysis. Furthermore, the peptidic inhibitors described herein have not been associated with reversible inhibition of the Bacillus pumilus protease described herein.

In particular, the present invention is based upon the surprising realization of the inventors that a Bacillus pumilus protease comprising an amino acid sequence which is at least 70% identical to the amino acid sequence given in SEQ ID NO:1 over its entire length and, in each case based upon the numbering according to SEQ ID NO:1 (i) at the positions corresponding to positions 9, 130, 133, 144, 217, 252, and 271, the amino acid substitutions 9T, 130D, 133A, 144K, 217M, 252T, and 271E, and (ii) at at least one, preferably two, and more preferably three, of the positions corresponding to positions 6, 89, 131, 166, 187, 189, 211, or 224, at least one further amino acid substitution selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, is advantageously stabilized in washing and cleaning agents by a peptidic inhibitor as defined herein. This is particularly surprising insofar as none of the peptidic inhibitors defined herein has previously been associated with improved stability of such a Bacillus pumilus protease in washing or cleaning agents. Furthermore, a peptidic inhibitor of this kind has not previously been associated with improved stability of further enzymes contained in the washing or cleaning agent if said peptidic inhibitors are present in the washing or cleaning agent together with the Bacillus pumilus protease mentioned.

According to the invention, peptides are used as peptidic inhibitors which have a length of 50 to 200, preferably 55 to 190, and more preferably 60 to 180, amino acid functional groups. Suitable peptidic inhibitors can be isolated, for example, from Streptomyces albogriseolus, Hordeum vulgare, Brachypodium distachyon, Populus trichocarpa, Triticum urartu, Setaria italica, and Oryza sativa. Preferred peptidic inhibitors are selected from peptides having an amino acid sequence that is at least 90% and increasingly preferably at least 91%, 92%, 93%, 94%, 95%, 96%, 97%, 98%, 99%, or 100% identical, over its total length, to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11, and SEQ ID NO:12. Particularly preferred are peptidic inhibitors having an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12. Particularly preferred are peptidic inhibitors having an amino acid sequence selected from the group consisting of SEQ ID NO:2, SEQ ID NO:4, SEQ ID NO:5, SEQ ID NO:8, or SEQ ID NO:11.

The agents according to the invention may comprise one or more peptidic inhibitor(s).

The agents according to the invention may contain the peptidic inhibitor(s) in a 0.5-1.0-, 1.5-, 2.0-, 2.5-, 3.0-, 3.5-, 4.0-, 4.5-, 5.0-, 10-, 15-, 18-, 20-, 25-, 27-, or 30-fold molar excess relative to the molarity of the protease used. This means that if 1 μmol of protease is present in an agent according to the invention, 0.5 μmol, 1 μmol, 1.5 μmol, 2.0 μmol, 2.5 μmol, 3.0 μmol, 3.5 μmol, 4.0 μmol, 4.5 μmol, 5.0 μmol, 10 μmol, 15 μmol, 18 μmol, 20 μmol, 25 μmol, 27 μmol, or 30 μmol of a corresponding peptidic inhibitor may be present. If a plurality of peptide inhibitors are contained, these specifications refer to the total concentration.

In a preferred embodiment, a peptidic inhibitor according to the invention increases the residual activity of a protease after storage (as described in example 2) by a factor of at least 1.1 to 2.5, preferably 1.2 to 2.0, and more preferably 1.3 to 1.9, when the protease is stored together with the peptide, compared to storage without peptide.

In a further preferred embodiment, a peptidic inhibitor according to the invention has an initial inhibitory capacity of at least 2.5 to 50, preferably 5 to 40, preferably 10 to 30, and more preferably 12.5 to 20.

In preferred embodiments, the protease contained in the washing agent according to the invention is a protease of Bacillus pumilus which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D/V, 133A, 144K, 217M, 252T, and 271E, and (ii) at at least two of the positions that correspond to positions 6, 89, 131, 166, 189, 211, or 224, at least one, preferably two, and more preferably three, of the positions that correspond to the positions 6, 89, 131, 166, 187, 189, 211, or 224, an additional amino acid substitution, selected from the group consisting of 6W/F, 89A/G, 131H/Y/F, 166M/L/I, 189T/L/I, 211N/Q, and 224A/G, preferably 6W, 89A, 131H, 166M, 189T, 211N, and 224A.

In further preferred embodiments, the protease used according to the invention exhibits proteolytic activity, comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 189, 211, or 224, at least one amino acid substitution, selected from the group consisting of Y6W, S89A, G131H, S166M, N187D, S189R, S189T, S211N, and S224A.

In further preferred embodiments, the protease used according to the invention exhibits proteolytic activity, comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 189, 211, or 224, at least two additional amino acid substitutions, selected from the group consisting of Y6W, S89A, G131H, S166M, N187D, S189R, S189T, S211N, and S224A.

In further preferred embodiments, the protease used according to the invention exhibits proteolytic activity, comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 189, 211, or 224, at least three additional amino acid substitutions, selected from the group consisting of Y6W, S89A, G131H, S166M, N187D, S189R, S189T, S211N, and S224A.

In further preferred embodiments, the protease used according to the invention exhibits proteolytic activity, comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A.

In particularly preferred embodiments, the washing agent according to the invention contains a protease having one of the following amino acid substitution variants:
(i) P9T-N130D-T133A-N144K-G166M-S189T-Y217M-N252T-Q271E;
(ii) P9T-N130D-T133A-N144K-G166M-S189T-Y217M-S224A-N252T-Q271E;
(iii) P9T-S89A-N130D-G131H-T133A-N144K-S189T-Y217M-S224A-N252T-Q271E;
(iv) Y6W-P9T-N130D-T133A-N144K-S189T-Y217M-S224A-N252T-Q271E;
(v) P9T-N130D-T133A-N144K-G166M-S211N-Y217M-N252T-Q271E;
(vi) P9T-S89A-N130D-T133A-N144K-S189T-Y217M-S224A-N252T-Q271E;
(vii) P9T-S89A-N130D-T133A-N144K-N187D-Y217M-S224A-N252T-Q271E;
(viii) P9T-S89A-N130D-T133A-N144K-S189R-Y217M-S224A-N252T-Q271E;
(ix) P9T-S89A-N130D-T133A-N144K-N187D-S189R-Y217M-S224A-N252T-Q271E,
the numbering being based in each case upon the numbering according to SEQ ID NO:1.

In preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 189T, 211N, and 224A, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence which is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:2.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:2.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:2.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:2.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:2.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:2.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:3.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:3.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:3.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:3.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:3.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:3.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO: 1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:4.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:4.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:4.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:4.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:4.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:4.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:5.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:5.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:5.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:5.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:5.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:5.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:6.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:6.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:6.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:6.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:6.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:6.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:7.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:7.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:7.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:7.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:7.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:7.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:8.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:8.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:8.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:8.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:8.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:8.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:9.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:9.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:9.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:9.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:9.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:9.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:10.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:10.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:10.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:10.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:10.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:10.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:11.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:11.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:11.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:11.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:11.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:11.

In further preferred embodiments, the agent according to the invention comprises
a) a protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A, and
b) a peptidic inhibitor having an amino acid sequence according to SEQ ID NO:12.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least one of the positions that correspond to positions 6, 89, 131, 166, 187, 189, 211, or 224, at least one amino acid substitution, selected from the group consisting of Y6W, S89A, G131H, S166M, N187D, S189R, S189T, S211N, and S224A, and
b) a peptidic inhibitor having an amino acid sequence according to SEQ ID NO:12.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least two of the positions that correspond to positions 6, 89, 131, 166, 187, 189, 211, or 224, at least two amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:12.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at at least three of the positions that correspond to positions 6, 89, 131, 166, 187, 189, 211, or 224, at least three amino acid substitutions, selected from the group consisting of Y6W, S89A, G131H, S166M, N187D, S189R, S189T, S211N, and S224A, and
b) a peptidic inhibitor having an amino acid sequence according to SEQ ID NO:12.

In further preferred embodiments, the agent according to the invention comprises
a) a protease that exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, and 98.8% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions P9T, N130D, T133A, N144K, Y217M, N252T, and Q271E, and (ii) at the positions that correspond to positions 89, 189, and 224, the amino acid substitutions S89A, S189T, and S224A, and
b) a peptidic inhibitor having an amino acid sequence according to SEQ ID NO:12.

In further preferred embodiments, the agent according to the invention comprises
a) a protease having one of the following amino acid substitution variants: P9T-N130D-T133A-N144K-G166M-S189T-Y217M-N252T-Q271E; P9T-N130D-T133A-N144K-G166M-S189T-Y217M-S224A-N252T-Q271E; P9T-S89A-N130D-G131H-T133A-N144K-S189T-Y217M-S224A-N252T-Q271E; Y6W-P9T-N130D-T133A-N144K-S189T-Y217M-S224A-N252T-Q271E; P9T-N130D-T133A-N144K-G166M-S211N-Y217M-N252T-Q271E; P9T-S89A-N130D-T133A-N144K-S189T-Y217M-S224A-N252T-Q271E; P9T-S89A-N130D-T133A-N144K-N187D-Y217M-S224A-N252T-Q271E; P9T-S89A-N130D-T133A-N144K-S189R-Y217M-S224A-N252T-Q271E; P9T-S89A-N130D-T133A-N144K-N187D-S189R-Y217M-S224A-N252T-Q271E, the numbering in each case referring to the numbering according to SEQ ID NO:1, and
b) a peptidic inhibitor having an amino acid sequence according to SEQ ID NO:12.

In washing or cleaning agents according to the invention, the washing or cleaning agent comprises, in each case relative to the total weight of the washing or cleaning agent, the enzyme, i.e., the protease, in an amount of 0.005 to 5 wt. %, preferably of 0.05 to 2 wt. %, more preferably of 0.01 to 0.5 wt. %, and still more preferably of 0.02 to 0.2 wt. %, and the peptidic inhibitor in an amount of 0.01 to 15 wt. %, preferably of 0.05 to 5 wt. %, more preferably of 0.1 to 1 wt. %, and still more preferably of 0.2 to 0.75 wt. %.

In various embodiments, the enzyme and the peptidic inhibitor can be pre-formulated in an enzyme composition. As is clear from the preceding remarks, the enzyme protein forms only a fraction of the total weight of conventional enzyme preparations. Protease preparations that are preferably used contain between 0.1 and 40 wt. %, preferably between 0.2 and 30 wt. %, particularly preferably between 0.4 and 20 wt. %, and in particular between 0.8 and 10 wt. %, of the enzyme protein. In such compositions, the peptidic inhibitor can be contained in an amount of 0.05 to 35 wt. %, preferably of 0.05 to 10 wt. %, relative to the total weight in the enzyme composition. This enzyme composition, which is also a component of the present invention, can then be used in washing or cleaning agents according to the invention, specifically in amounts which lead to the final concentrations in the washing or cleaning agent indicated herein.

The proteases used according to the invention exhibit enzymatic activity, i.e., they are capable of hydrolyzing peptides and proteins, in particular in washing or cleaning agents. A protease used according to the invention is therefore an enzyme which catalyzes the hydrolysis of amide/peptide bonds in protein/peptide substrates and is thus able to cleave proteins or peptides. Furthermore, a protease according to the invention is preferably a mature protease, i.e., the catalytically active molecule without signal peptide(s) and/or propeptide(s). Unless otherwise stated, the sequences indicated also refer to mature (processed) enzymes in each case.

In various embodiments of the invention, the protease is a free enzyme. This means that the protease can act directly with all components of an agent and, if the agent is a liquid agent, the protease is directly in contact with the solvent of the agent (e.g., water). In other embodiments, an agent may contain proteases that form an interaction complex with other molecules or that contain a “coating.” In this case, one or more protease molecules can be separated from the other constituents of the agent by a structure surrounding them. Such a separating structure can arise due to, but is not limited to, vesicles, such as a micelle or a liposome. However, the surrounding structure may also be a virus particle, a bacterial cell, or a eukaryotic cell. In various embodiments, an agent may include cells of Bacillus pumilus or Bacillus subtilis which express the proteases according to the invention, or cell culture supernatants of such cells.

In connection with the present invention, the feature whereby a protease has the given substitutions means that it contains one (of the given) substitution(s) at the relevant position, i.e., at least the given positions are not otherwise mutated or deleted—for example, by fragmentation of the protease. In various embodiments, the proteases described herein, with the exception of the explicitly mentioned substitutions, have the sequence of SEQ ID NO:1, i.e., apart from the substituted positions, they are 100% identical to the sequence according to SEQ ID NO:1.

The identity of nucleic acid or amino acid sequences is determined by a sequence comparison. This sequence comparison is based upon the BLAST algorithm established and commonly used in the prior art (cf., e.g., Altschul et al. (1990), “Basic local alignment search tool,” J. Mol. Biol., 215:403-410, and Altschul et al. (1997), “Gapped BLAST and PSI-BLAST: a new generation of protein database search programs,” Nucleic Acids Res., 25:3389-3402) and occurs in principle by similar sequences of nucleotides or amino acids in the nucleic acid or amino acid sequences being assigned to one another. A tabular assignment of the relevant positions is referred to as an alignment. A further algorithm available in the prior art is the FASTA algorithm. Sequence comparisons (alignments), in particular multiple sequence comparisons, are created using computer programs. The Clustal series (cf., e.g., Chenna et al. (2003), “Multiple sequence alignment with the Clustal series of programs,” Nucleic Acid Res. 31:3497-3500), T-Coffee (cf., e.g., Notredame et al. (2000), “T-Coffee: A novel method for multiple sequence alignments,” J. Mol. Biol., 302:205-217) or programs based upon these programs or algorithms, for example, are frequently used. Also possible are sequence comparisons (alignments) using the computer program Vector NTI® Suite 10.3 (Invitrogen Corporation, 1600 Faraday Avenue, Carlsbad, California, USA) with the specified standard parameters, the AlignX module of which for the sequence comparisons is based upon ClustalW, or Clone Manager 10 (use of the scoring matrix BLOSUM 62 for sequence alignment at amino acid level). Unless stated otherwise, the sequence identity indicated herein is determined using the BLAST algorithm.

Such a comparison also allows a conclusion to be drawn about the similarity of the compared sequences to one another. It is usually given in percent identity, i.e., the proportion of identical nucleotides or amino acid residues at the same positions or positions corresponding to one another in an alignment. In the case of amino acid sequences, the broader concept of homology takes conserved amino acid exchanges into account, i.e., amino acids having similar chemical activity, because these usually perform similar chemical activities within the protein. Therefore, the similarity of the compared sequences can also be indicated as percent homology or percent similarity. Identity and/or homology information can be provided regarding whole polypeptides or genes or only regarding individual regions. Homologous or identical regions of different nucleic acid or amino acid sequences are therefore defined by matches in the sequences. Such regions often have identical functions. They can be small and comprise only a few nucleotides or amino acids. Often, such small regions perform essential functions for the overall activity of the protein. It may therefore be expedient to relate sequence matches only to individual, optionally small, regions. Unless otherwise stated, however, identity or homology information in the present application relates to the entire length of the particular nucleic acid or amino acid sequence indicated.

In connection with the present invention, the indication that an amino acid position corresponds to a numerically designated position in SEQ ID NO:1 therefore means that the corresponding position is associated with the numerically designated position in SEQ ID NO:1 in an alignment as defined above. Furthermore, the assignment of the positions is based upon the mature protein. This assignment is also to be used in particular when the amino acid sequence of a protease according to the invention comprises a higher number of amino acid functional groups than the protease from Bacillus pumilus according to SEQ ID NO:1. Proceeding from the stated positions in the amino acid sequence of the protease from Bacillus pumilus, the alteration positions in a protease according to the invention are those which are assigned to said positions in an alignment.

For the description of substitutions that relate to exactly one amino acid position (amino acid exchanges), the following convention is applied herein: first, the naturally present amino acid is referred to in the form of the internationally used single-letter code, followed by the associated sequence position, and finally the inserted amino acid. Several or alternative exchanges within the same polypeptide chain are separated by slashes. “130D/V” thus means that position 130 has mutated to D or V. In the case of insertions, additional amino acids are named according to the sequence position. In the case of deletions, the missing amino acid is replaced by a symbol, e.g., a star or a dash, or a A is indicated before the corresponding position. For example, P9T describes the substitution of proline at position 9 by threonine, P9TH describes the insertion of histidine following the amino acid threonine at position 9 and P9* or ΔP9 describes the deletion of proline at position 9. This nomenclature is known to a person skilled in the art in the field of enzyme technology.

Advantageous positions for sequence alterations, in particular substitutions, of the protease from Bacillus pumilus, which are of particular significance when transferred to homologous positions of the proteases according to the invention and which impart advantageous functional properties to the protease, are therefore the positions which correspond to the positions described herein in an alignment, i.e., in the numbering according to SEQ ID NO:1. The following amino acid functional groups are located at the positions mentioned in the wild type molecule of the protease from Bacillus pumilus: P9, N130, T133, N144, Y217, N252, and Q271 as well as Y6, S89, G131, G166, N187, S189, S211, and 5224.

In a further embodiment of the invention, a previously described protease is additionally stabilized, in particular by means of one or more mutations, e.g., substitutions, or by means of coupling to a polymer. An increase in stability during storage and/or during use, e.g., during the washing process, results in the enzymatic activity lasting longer, and thus improves the cleaning performance. In principle, all stabilization options described and/or expedient in the prior art are conceivable. Preference is given to those stabilizations which are achieved via mutations of the enzyme itself, because such stabilizations do not require any further working steps after the recovery of the enzyme. Examples of sequence alterations suitable for this purpose are specified above. Further suitable sequence alterations are known from the prior art.

Further possibilities for stabilization are, for example:
altering the binding of metal ions, in particular the calcium binding sites—for example, by exchanging one or more of the amino acid(s) involved in the calcium binding for one or more negatively charged amino acids and/or by introducing sequence changes in at least one of the sequences of the two amino acids arginine/glycine;
protecting against the influence of denaturing agents such as surfactants by mutations which cause an alteration of the amino acid sequence on or at the surface of the protein;
exchanging amino acids that are close to the N-terminus for those that presumably come into contact with the rest of the molecule via non-covalent interactions and thus contribute to maintaining the globular structure.

Preferred embodiments are those in which the enzyme is stabilized in a plurality of ways because a plurality of stabilizing mutations act additively or synergistically.

In addition, at least one further stabilizer compound selected from the group consisting of polyols, in particular glycerol and 1,2-propylene glycol, benzamidine hydrochloride, borax, boric acids, boronic acids, or their salts or esters or derivatives, in particular phenylboronic acid derivatives or 4-formylphenylboronic acid (4-FPBA), and combinations thereof, may also be present.

In the context of the present invention, “phenylboronic acid derivative” is understood to mean a compound of formula (I). The compound of formula (I) has the following structural formula:

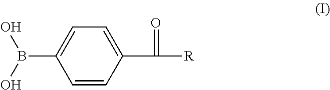

where R is hydrogen, a hydroxyl group, a C₁₋₆ alkyl group, a substituted C₁₋₆ alkyl group, a C₁₋₆ alkenyl, or a substituted C₁₋₆ alkenyl group. Preferably, the functional group R in the phenylboronic acid derivative is a C₁₋₆ alkyl group and, among these, is more preferably —CH₃, —CH₃CH₂, or —CH₃CH₂CH₂. More preferably, the functional group R in the phenylboronic acid derivative is hydrogen. Particularly preferably, the phenylboronic acid derivative is 4-formylphenylboronic acid (4-FPBA).

The other stabilizer compound used can be boric acid.

The agent according to the invention is preferably substantially free of further stabilizer compounds. Very particularly preferably, the agent according to the invention does not comprise any of the further stabilizer compounds mentioned in addition to the peptidic inhibitors according to the invention.

In particularly preferred embodiments, the washing and cleaning agent according to the invention is substantially free of boron-containing compounds. “Substantially free of boron-containing compounds” in this connection means that the agents according to the invention contain less than 2 wt. %, preferably less than 1 wt. %, more preferably less than 0.5 wt. %, and particularly preferably less than 0.1 wt. %, of boron-containing compounds, relative to the total weight of the agent. In very particularly preferred embodiments, the washing and cleaning agents according to the invention are free of boron-containing compounds, i.e., in particular they do not contain boric acid and/or phenylboronic acid derivatives.

It is possible for a person skilled in the art to use methods which are currently generally known, e.g., chemical synthesis or polymerase chain reaction (PCR), in conjunction with molecular biological and/or protein-chemical standard methods, to produce the corresponding nucleic acids and even complete genes on the basis of known DNA and/or amino acid sequences. Such methods are known, for example, from Sambrook, J., Fritsch, E. F., and Maniatis, T., 2001, Molecular cloning: a laboratory manual, 3rd Edition, Cold Spring Laboratory Press.

In a further embodiment of the invention, the protease is characterized in that the cleaning performance thereof is not significantly reduced compared with that of a protease comprising an amino acid sequence that corresponds to the amino acid sequence given in SEQ ID NO:1, i.e., has at least 80% of the reference washing performance, preferably at least 100%, and more preferably at least 110% or more.

Washing or cleaning performance is understood to mean the ability of a washing or cleaning agent to partially or completely remove existing soiling, in particular the lightening performance on one or more instances of soiling on textiles. Examples of such stains are blood on cotton or chocolate milk/soot on cotton, cocoa on cotton, or porridge on cotton. Within the scope of the invention, both the washing or cleaning agent, which comprises the protease, or the washing or cleaning liquor formed by this agent, and the protease itself have a cleaning performance. The cleaning performance of the protease thus contributes to the cleaning performance of the agent or the washing or cleaning liquor formed by the agent.

Washing or cleaning liquor is understood to mean the solution containing the washing or cleaning agent which acts upon the textiles or hard surfaces and thus comes into contact with the stains present on the textiles or hard surfaces. The washing or cleaning liquor is usually created when the washing or cleaning process begins and the washing or cleaning agent is diluted with water—for example, in a washing machine or dishwasher or in another suitable container.

The cleaning performance can be determined in a washing system containing a washing agent in a dosage between 2.0 and 8.0 grams per liter of washing liquor and the enzyme. The enzymes to be compared are used in the same concentration (based upon active protein). The activity-equivalent use of the relevant enzyme ensures that the respective enzymatic properties, e.g., the cleaning performance on certain stains, are compared even if the ratio of active substance to total protein (the values of the specific activity) diverges. In general, a low specific activity can be compensated for by adding a larger amount of protein. Furthermore, the enzymes to be examined can also be used in the same amount of substance or amount by weight if the enzymes to be examined have a different affinity for the test substrate in an activity test. The expression “same amount of substance” in this context relates to a molar use of the enzymes to be examined. The expression “equal weight” relates to the use of the same weight of the enzymes to be examined.

The concentration of the protease in the washing agent intended for such a washing system is 0.001 to 0.1 wt. %, preferably 0.01 to 0.06 wt. %, relative to active protein.

A liquid reference washing agent for such a washing system may be composed, for example, as follows (all figures in percent by weight (wt. %)): 4.4% alkyl benzene sulfonic acid, 5.6% further anionic surfactants, 2.4% C₁₂-C₁₈ Na salts of fatty acids (soaps), 4.4% non-ionic surfactants, 0.2% phosphonates, 1.4% citric acid, 0.95% NaOH, 0.01% defoamer, 2% glycerol, 0.08% preservatives, 1% ethanol—the remainder being demineralized water. The dosage of the liquid washing agent is preferably between 4.5 and 6.0 grams per liter of washing liquor—for example, 4.7, 4.9 or 5.9 grams per liter of washing liquor. The washing process preferably takes place in a pH range between pH 7 and pH 10.5, preferably between pH 8 and pH 9.

The cleaning performance is determined with respect to soiling on cotton by measuring the degree of cleaning of the washed textiles. For example, the washing process can take place for 60 minutes at a temperature of 40° C. and the water can have a water hardness between 15.5° dH and 16.5° dH (German hardness).

The degree of whiteness, i.e., the lightening of the stains, as a measure of the cleaning performance is determined using optical measuring methods, preferably photometrically. A suitable device for this is, for example, the Minolta CM508d spectrometer. Usually, the devices used for measurement are calibrated beforehand using a white standard, preferably a supplied white standard.

Preferred embodiments of proteases according to the invention achieve such advantageous cleaning performance even at low temperatures, in particular in the temperature ranges between 1° and 60° C., preferably between 15 and 50° C., and particularly preferably between 2° and 40° C.

The protein concentration can be determined using known methods, e.g., the BCA method (bicinchoninic acid; 2,2′-bichinolyl-4,4′-dicarboxylic acid) or the Biuret method (Gornall et al., 1948, J. Biol. Chem., 177:751-766). The active protein concentration can be determined in this regard by titrating the active centers using a suitable irreversible inhibitor and determining the residual activity (Bender et al., 1966, J. Am. Chem. Soc. 88, 24:5890-5913).

According to the invention, all conceivable types of washing or cleaning agents are to be understood as washing or cleaning agents, both concentrates and undiluted agents, for use on a commercial scale, in washing machines or for hand washing or cleaning. These include, for example, washing agents for textiles, carpets, or natural fibers, for which the term washing agent is used. These include, for example, dishwashing detergents for dishwashers (dishwashing detergents) or manual dishwashing detergents or cleaners for hard surfaces such as metal, glass, porcelain, ceramics, tiles, stone, painted surfaces, plastics, wood, or leather, for which the term cleaning agent is used, i.e., in addition to manual and mechanical dishwashing detergents, also, for example, scouring agents, glass cleaners, WC toilet centers, etc. The washing and cleaning agents according to the invention also include auxiliary washing agents which are added to the actual washing agent during manual or automatic textile washing in order to achieve a further effect. Furthermore, in the context of the invention, washing and cleaning agents also include textile pre-treatment agents and post-treatment agents, i.e., those agents with which the item of laundry is brought into contact before the actual washing, e.g., for dissolving stubborn stains, and also those agents which give the laundry further desirable properties, such as a pleasant feel, crease resistance, or a low static charge in a step downstream of the actual textile washing. Inter alia, softeners are included in the latter agents.

The washing or cleaning agents according to the invention, which may be in the form of powdered or granular solids, in compacted or further-compacted particulate form, as homogeneous solutions or suspensions, may contain, in addition to a tannase according to the invention, all known ingredients conventional in such agents, with preferably at least one other ingredient being present in the agent. The agents according to the invention can in particular contain surfactants, builders, polymers, glass corrosion inhibitors, corrosion inhibitors, bleaching agents such as peroxygen compounds, bleach activators, or bleach catalysts. They may also contain water-miscible organic solvents, further enzymes, enzyme stabilizers, sequestering agents, electrolytes, pH regulators and/or further auxiliaries, such as optical brighteners, graying inhibitors, dye transfer inhibitors, foam regulators, as well as dyes and fragrances, and combinations thereof.

Advantageous ingredients of agents according to the invention are disclosed in international patent application WO 2009/121725, starting at the penultimate paragraph of page 5 and ending after the second paragraph on page 13. Reference is expressly made to this disclosure, and the disclosure therein is incorporated into the present patent application.

An agent according to the invention advantageously contains the tannase in an amount of 2 g to 20 mg, preferably of 5 g to 17.5 mg, particularly preferably of 20 g to 15 mg, and very particularly preferably of 50 g to 10 mg per g of the agent. In various embodiments, the concentration of the protease (active enzyme) described herein in the agent is >0 to 1 wt. %, preferably 0.0001 or 0.001 to 0.1 wt. %, relative to the total weight of the agent or composition.

The agent according to the invention contains the tannase in an amount, increasingly preferably, of 1×10⁻⁸ to 5 wt. %, of 0.0001 to 1 wt. %, of 0.0005 to 0.5 wt. %, of 0.001 to 0.1 wt. %, in each case relative to active protein and relative to the total weight of the washing agent.

An agent according to the invention increasingly preferably contains the protease in an amount of 0.1 μmol to 2 μmol, preferably 0.2 μmol to 1.5 μmol, and more preferably 0.5 μmol to 1 μmol.

The embodiments of the present invention include all solid, powdered, liquid, gel, or pasty administration forms of agents according to the invention, which may optionally also consist of a plurality of phases and can be present in compressed or uncompressed form. The agent can be present as a free-flowing powder, in particular having a bulk density of 300 g/L to 1,200 g/L, in particular 500 g/L to 900 g/L or 600 g/L to 850 g/L. The solid administration forms of the agent further include extrudates, granules, tablets, or pouches. Alternatively, the agent can also be in a liquid, gel, or paste form—for example, in the form of a non-aqueous liquid washing agent or a non-aqueous paste or in the form of an aqueous liquid washing agent or a water-containing paste. Liquid agents are generally preferred. Furthermore, the agent can be present as a single-component system. Such agents consist of one phase. Alternatively, an agent can also consist of a plurality of phases. Such an agent is accordingly divided into a plurality of components.

If the washing agents according to the invention are in liquid form, they preferably contain more than 40 wt. %, preferably 50 to 90 wt. %, and particularly preferably 60 to 80 wt. %, water, relative to their total weight.

The agents according to the invention can contain one or more surfactants, with anionic surfactants, non-ionic surfactants, and mixtures thereof being particularly suitable, although cationic, zwitterionic, and/or amphoteric surfactants can also be contained. The agents preferably contain 5 to 70 wt. % surfactant, preferably 5 to 60 wt. %, and more preferably 5 to 50 wt. % surfactant.

Suitable anionic surfactants are, in particular, soaps and those which contain sulfate or sulfonate groups, preferably having alkali ions as cations. Usable soaps are preferably the alkali salts of saturated or unsaturated C₁₂₋₁₈ fatty acids. Fatty acids of this kind can also be used in a not completely neutralized form. Suitable sulfate-type surfactants include the salts of sulfuric acid half-esters of C₁₂₋₁₈ fatty alcohols and the sulfation products of the mentioned non-ionic surfactants having a low degree of ethoxylation. Surfactants of the sulfonate type that can be used include, for example, C₉₋₁₄ alkylbenzene sulfonates, alkane sulfonates which are obtained from C₁₂₋₁₈ alkanes, e.g., by sulfochlorination or sulfoxidation with subsequent hydrolysis or neutralization, C₁₂₋₁₈ olefin sulfonates resulting from the reaction of corresponding monoolefins with sulfur trioxide, mixtures of alkene and hydroxyalkane sulfonates, disulfonates, such as those obtained from C₁₂₋₁₈ monoolefins with terminal or internal double bonds by sulfonation with gaseous sulfur trioxide and subsequent alkaline or acidic hydrolysis of the sulfonation products, and α-sulfofatty acid esters (ester sulfonates) resulting from the sulfonation of fatty acid methyl or ethyl esters, e.g., α-sulfonated methyl esters of hydrogenated coconut, palm kernel, or tallow fatty acids.

The agent preferably comprises 2 to 55 wt. %, and more preferably 3 to 35 wt. %, anionic surfactant. Very particularly preferably, the agent comprises 3 to 25 wt. % alkylbenzene sulfonate. In addition, the agent can preferably also contain other anionic surfactants, in particular alkyl ether sulfates, and non-ionic surfactants, in particular fatty alcohol alkoxylates. These can then make up the remainder of the surfactants.

Suitable alkylbenzene sulfonates are preferably selected from linear or branched alkylbenzene sulfonates of the formula

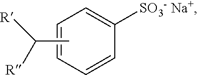

in which R′ and R″ are, independently of one another, hydrogen or alkyl, and together contain 6 to 19, preferably 7 to 15, and in particular 9 to 13, C atoms. A very particularly preferred representative is sodium dodecylbenzene sulfonate.

The alkali salts and in particular the sodium salts of the sulfuric acid half-esters of C₁₂₋₁₈ fatty alcohols, e.g., from coconut fatty alcohol, tallow fatty alcohol, lauryl alcohol, myristyl alcohol, cetyl alcohol, or stearyl alcohol, or of C₁₀₋₂₀ oxo alcohols and the half-esters of secondary alcohols having these chain lengths are preferred as alk(en)yl sulfates. Alk(en)yl sulfates of the mentioned chain length that contain a synthetic straight-chain alkyl functional group prepared on a petrochemical basis and have a degradation behavior similar to that of the adequate compounds based upon fat chemical raw materials are also preferred. From a washing perspective, the C₁₂₋₁₆ alkyl sulfates and C₁₂₋₁₅ alkyl sulfates and also C₁₄₋₁₅ alkyl sulfates are preferred.

The sulfuric acid monoesters of straight-chain or branched C₇₋₂₁ alcohols ethoxylated with 1 to 6 moles ethylene oxide, such as 2-methyl-branched C₉₋₁₁ alcohols having, on average, 3.5 moles ethylene oxide (EO) or C₁₂₋₁₈ fatty alcohols having 1 to 4 EO, are also suitable.

Suitable alkyl ether sulfates are, for example, compounds of the formula

R¹—O-(AO)ₙ—SO₃⁻X⁺.

In this formula, R¹ represents a linear or branched, substituted or unsubstituted alkyl functional group, preferably a linear, unsubstituted alkyl functional group, particularly preferably a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂₋₁₈ fatty alcohols for example, from coconut fatty alcohol, tallow fatty alcohol, lauryl, myristyl, cetyl or stearyl alcohol, or from C₁₀₋₂₀ oxo alcohols. AO represents an ethylene oxide (EO) group or propylene oxide (PO) group, preferably an ethylene oxide group. The index n represents an integer from 1 to 50, preferably from 1 to 20, and in particular from 2 to 10. Very particularly preferably, n represents the numbers 2, 3, 4, 5, 6, 7, or 8. X⁺ represents a monovalent cation or the n-th part of an n-valent cation, the alkali metal ions, including Na⁺ or K⁺, being preferred in this case, with Na⁺ being most preferred. Further cations X⁺ may be selected from NH₄⁺, ½Zn²⁺, ½Mg²⁺, ½Ca²⁺, ½Mn²⁺, and the mixtures thereof.

In various embodiments, the alkyl ether sulfate can be selected from fatty alcohol ether sulfates of the formula

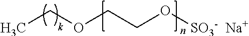

where k=11 to 19, and n=2, 3, 4, 5, 6, 7, or 8. Very particularly preferred representatives are Na—C₁₂₋₁₄ fatty alcohol ether sulfates having 2 EO (k=11-13, n=2). The degree of ethoxylation indicated represents a statistical average value which can be an integer or a fractional number for a specific product. The degrees of alkoxylation indicated represent statistical averages which can be an integer or a fractional number for a specific product. Preferred alkoxylates/ethoxylates have a narrowed homolog distribution (narrow range ethoxylates, NRE).

It has proven advantageous for cold-wash performance if the washing agents additionally contain soap(s). Preferred washing agents are therefore characterized in that they contain soap(s). Saturated fatty acid soaps are suitable, such as the salts of lauric acid, myristic acid, palmitic acid, stearic acid, hydrogenated erucic acid, and behenic acid, and in particular soap mixtures derived from natural fatty acids, such as coconut fatty acids, palm kernel fatty acids, or tallow fatty acids.

Suitable non-ionic surfactants are in particular alkyl glycosides and ethoxylation and/or propoxylation products of alkyl glycosides or linear or branched alcohols each having 8 to approximately 18 C atoms in the alkyl portion and 3 to 20, preferably 4 to 10, alkyl ether groups. Furthermore, corresponding ethoxylation and/or propoxylation products of N-alkylamines, vicinal diols, fatty acid esters, and fatty acid amides, which correspond to the above-mentioned long-chain alcohol derivatives with respect to the alkyl moiety, and of alkylphenols having 5 to 12 C atoms in the alkyl functional group, may be used.

Non-ionic surfactants that are preferably used are alkoxylated, advantageously ethoxylated, in particular primary alcohols having preferably 8 to 18 C atoms and, on average, 1 to 12 moles of ethylene oxide (EO) per mole of alcohol, in which the alcohol functional group can be linear or preferably methyl-branched in position 2, or can contain linear and methyl-branched functional groups in admixture, as are usually present in oxo alcohol functional groups. However, alcohol ethoxylates having linear functional groups of alcohols of native origin having 12 to 18 C atoms, e.g., of coconut, palm, tallow fatty, or oleyl alcohol, and an average of 2 to 8 EO per mole of alcohol, are particularly preferred. Preferred ethoxylated alcohols include, for example, C₁₂₋₁₄ alcohols having 3 EO or 4 EO, C₉₋₁₁ alcohols having 7 EO, C₁₃₋₁₅ alcohols having 3 EO, 5 EO, 7 EO, or 8 EO, C₁₂₋₁₈ alcohols having 3 EO, 5 EO, or 7 EO, and mixtures thereof, such as mixtures of C₁₂₋₁₄ alcohol having 3 EO and C₁₂₋₁₈ alcohol having 5 EO. The degrees of ethoxylation specified represent statistical averages that can correspond to an integer or a fractional number for a specific product. Preferred alcohol ethoxylates have a narrowed homolog distribution (narrow range ethoxylates, NRE). In addition to these non-ionic surfactants, fatty alcohols having more than 12 EO can also be used. Examples of these are tallow fatty alcohols having 14 EO, 25 EO, 30 EO, or 40 EO.

Another class of non-ionic surfactants that are preferably used, which are used either as the sole non-ionic surfactant or in combination with other non-ionic surfactants, are alkoxylated, preferably ethoxylated or ethoxylated and propoxylated fatty acid alkyl esters, preferably having 1 to 4 carbon atoms in the alkyl chain, in particular fatty acid methyl esters.

Another class of non-ionic surfactants that can advantageously be used are the alkyl polyglycosides (APG). Applicable alkyl polyglycosides satisfy the general formula

RO(G)_{z},

in which R represents a linear or branched, in particular methyl-branched at the 2-position, saturated or unsaturated aliphatic functional group having 8 to 22, preferably 12 to 18, C atoms, and G is the symbol that represents a glycose unit having 5 or 6 C atoms, preferably glucose. The degree of glycosidation z is between 1 and 4, preferably between 1 and 2, and in particular between 1.1 and 1.4. Linear alkyl polyglycosides, i.e., alkyl polyglycosides in which the polyglycol functional group is a glucose functional group and the alkyl functional group is an n-alkyl functional group, are preferably used.

Non-ionic surfactants of the aminoxide type, e.g., N-cocoalkyl-N,N-dimethylamine oxide and N-tallow-alkyl-N,N-dihydroxyethylamine oxide, and of the fatty acid alkanolamides may also be suitable. The quantity of these non-ionic surfactants is preferably no more than that of the ethoxylated fatty alcohols, in particular no more than half thereof.

Suitable amphoteric surfactants are, for example, betaines of the formula

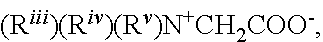

in which Rⁱⁱⁱ denotes an alkyl group, which is optionally interrupted by heteroatoms or heteroatom groups, having 8 to 25, preferably 10 to 21, carbon atoms, and R^{iv} and R^{v} denote identical or different alkyl functional groups having 1 to 3 carbon atoms, in particular C₁₀₋₁₈ alkyl dimethyl carboxymethyl betaine and C₁₁₋₁₇ alkyl amidopropyl dimethyl carboxymethyl betaine.

Suitable cationic surfactants include among others the quaternary ammonium compounds of the formula

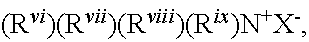

in which R^{vi} to R^{ix} represent four identical or different, in particular two long-chain and two short-chain, alkyl functional groups, and X⁻ represents an anion, in particular a halide ion, e.g., didecyldimethyl ammonium chloride, alkylbenzyldidecyl ammonium chloride, and mixtures thereof. Further suitable cationic surfactants are the quaternary surface-active compounds, in particular having a sulfonium, phosphonium, iodonium, or arsonium group, which are also known as antimicrobial active ingredients. By using quaternary surface-active compounds having an antimicrobial effect, the agent can be provided with an antimicrobial effect, or the antimicrobial effect that may already be present due to other ingredients can be improved.

Complexing agents are another preferred component of washing agents according to the invention. Particularly preferred complexing agents are the phosphonates, provided that their use is permitted by regulations. In addition to 1-hydroxyethane-1,1-diphosphonic acid, the complexing phosphonates include a number of different compounds such as diethylenetriamine penta(methylene phosphonic acid) (DTPMP). Hydroxy alkane or aminoalkane phosphonates are particularly preferred in this application. Among the hydroxyalkane phosphonates, 1-hydroxyethane-1,1-diphosphonate (HEDP) is of particular importance as a cobuilder. It is preferably used as a sodium salt, the disodium salt reacting in a neutral manner and the tetrasodium salt reacting in an alkaline manner (pH 9). Possible amino alkane phosphonates preferably include ethylenediamine tetramethylene phosphonate (EDTMP), diethylenetriamine pentamethylene phosphonate (DTPMP), and the higher homologs thereof. They are preferably used in the form of the neutral-reacting sodium salt, e.g., as the hexasodium salt of EDTMP or as the heptasodium and octasodium salt of DTPMP. Of the class of phosphonates, HEDP is preferably used as a builder. The aminoalkane phosphonates additionally have a pronounced capability of binding heavy metals. Accordingly, it may be preferred, in particular if the agents also contain bleach, to use aminoalkane phosphonates, in particular DTPMP, or to use mixtures of the aforementioned phosphonates. A preferred washing agent in the context of this application contains one or more phosphonate(s) from the group aminotrimethylene phosphonic acid (ATMP) and/or the salts thereof; ethylenediamine tetra(methylene phosphonic acid) (EDTMP) and/or the salts thereof; diethylenetriamine penta(methylene phosphonic acid) (DTPMP) and/or the salts thereof; 1-hydroxyethane-1,1-diphosphonic acid (HEDP) and/or the salts thereof; 2-phosphonobutane-1,2,4-tricarboxylic acid (PBTC) and/or the salts thereof; hexamethylenediamine tetra(methylene phosphonic acid) (HDTMP) and/or the salts thereof; nitrilotri(methylene phosphonic acid) (NTMP) and/or the salts thereof. Washing agents which contain 1-hydroxyethane-1,1-diphosphonic acid (HEDP) or diethylene triaminepenta(methylene phosphonic acid) (DTPMP) as phosphonates are particularly preferred. The washing agents according to the invention may, of course, contain two or more different phosphonates. Washing agents that are preferred according to the invention are characterized in that the washing agent contains at least one complexing agent from the group of phosphonates, preferably 1-hydroxyethane-1,1-diphosphonate, the proportion by weight of the phosphonate with respect to the total weight of the washing agent preferably being between 0.1 and 8.0 wt. %, more preferably 0.2 and 5.0 wt. %, even more preferably 0.3 and 3.0 wt. %, and particularly preferably 0.5-2.0 wt. %.

The washing agents according to the invention also preferably contain builders, preferably at least one water-soluble and/or water-insoluble, organic, and/or inorganic builder. The builders include in particular the silicates, carbonates, and/organic cobuilders.

Polycarboxylates/polycarboxylic acids, polymeric polycarboxylates, aspartic acid, polyacetals, dextrins, other organic cobuilders and phosphonates are particularly noteworthy as organic cobuilders. These substance classes are described below. Organic cobuilder substances of this kind can, if desired, be contained in amounts of up to 40 wt. %, in particular up to 25 wt. %, and preferably of 1 to 8 wt. %. Suitable organic builder substances are, for example, the polycarboxylic acids that can be used in the form of the free acids and/or the sodium salts thereof, where polycarboxylic acids are understood to mean the carboxylic acids which carry more than one acid function. For example, these are citric acid, adipic acid, succinic acid, glutaric acid, malic acid, tartaric acid, maleic acid, fumaric acid, saccharic acid, and carboxylmethylinulin, monomeric, and polymeric aminopolycarboxylic acids, in particular glycinediacetic acid, methylglycinediacetic acid, nitrilotriacetic acid (NTA), iminodisuccinates such as ethylenediamine-N,N′-disuccinic acid and hydroxyiminodisuccinate, ethylenediaminetetraacetic acid and polyaspartic acid, polyphosphonic acids, in particular aminotris(methylene phosphonic acid), ethylenediamine tetrakis(methylene phosphonic acid), lysine tetra(methylene phosphonic acid) and 1-hydroxyethane-1,1-diphosphonic acid, polymeric hydroxy compounds such as dextrin, and polymeric (poly)carboxylic acids, polycarboxylates which can be obtained in particular by oxidizing polysaccharides or dextrins, and/or polymeric acrylic acids, methacrylic acids, maleic acids, and mixed polymers thereof, which may also contain, polymerized in the polymer, small proportions of polymerizable substances, without a carboxylic acid functionality. Organic builder substances of this kind can, if desired, be contained in amounts of up to 50 wt. %, in particular up to 25 wt. %, preferably of 10 to 20 wt. % and particularly preferably of 1 to 5 wt. %. In addition to their builder effect, the free acids typically also have the property of being an acidification component and are thus also used for setting a lower and milder pH of washing agents. Particularly noteworthy here are citric acid, succinic acid, glutaric acid, adipic acid, gluconic acid, and any mixtures thereof. Citric acid or salts of citric acid are particularly preferably used as builder substances. Further particularly preferred builder substances are selected from methylglycinediacetic acid (MGDA), glutamic acid diacetate (GLDA), aspartic acid diacetate (ASDA), hydroxyethyl-iminodiacetate (HEIDA), iminodisuccinate (IDS), ethylenediamine disuccinate (EDDS), carboxymethyl inulin, and polyaspartate. In preferred embodiments, citric acid and/or citrate is used as the water-soluble, organic builder. It is particularly preferred to use 0.5 to 25 wt. %, preferably 0.75 to 12.5 wt. %, more preferably 1 to 4 wt. %, citric acid and/or 0.5 to 25 wt. %, preferably 0.75 to 12.5 wt. %, more preferably 1 to 4 wt. %, citrate, preferably alkali citrate, more preferably sodium citrate. Citric acid/citrate can each be used in the form of their hydrates, e.g., citric acid can be used in the form of the monohydrate, and citrate can be used in the form of the trisodium citrate dihydrate.

Polymeric polycarboxylates are also suitable as builders. These are, for example, the alkali metal salts of polyacrylic acid or polymethacrylic acid—for example, those having a relative molecular mass of 500 to 70,000 g/mol. For the purpose of this application, the molar masses indicated for polymeric polycarboxylates are weight-average molar masses Mw of the particular acid form which have been determined in principle using gel permeation chromatography (GPC), wherein a UV detector has been used. The measurement was carried out against an external polyacrylic acid standard which, due to the structural relationship to the tested polymers, yields realistic molecular weight values. These specifications differ significantly from the molecular weight specifications for which polystyrene sulfonic acids are used as the standard. The molar masses measured against polystyrene sulfonic acids are generally considerably higher than the molar masses indicated in this application. Suitable polymers are in particular polyacrylates which preferably have a molecular mass of 2,000 to 20,000 g/mol. Due to their superior solubility, short-chain polyacrylates having molar masses of 2,000 to 10,000 g/mol, and particularly preferably of 3,000 to 5,000 g/mol, may in turn be preferred from this group. In addition, copolymeric polycarboxylates are suitable, in particular those of acrylic acid with methacrylic acid and those of acrylic acid or methacrylic acid with maleic acid. Copolymers of acrylic acid with maleic acid which contain 50 wt. % to 90 wt. % acrylic acid and 50 wt. % to 10 wt. % maleic acid have been found to be particularly suitable. The relative molecular mass thereof, based upon free acids, is generally 2,000 to 70,000 g/mol, preferably 20,000 to 50,000 g/mol, and in particular 30,000 to 40,000 g/mol.

A solid agent according to the invention preferably contains at least one water-soluble and/or water-insoluble, organic and/or inorganic builder. The water-soluble organic builder substances include the above-mentioned organic builder substances.

In addition to the water-soluble organic builders mentioned above, the agents of the invention may also further contain inorganic water-soluble builders. In particular, alkali silicates, alkali carbonates, alkali hydrogen carbonates, alkali phosphates and/or sesquicarbonates, which can be present in the form of their alkaline, neutral, or acidic sodium or potassium salts, can be used as water-soluble inorganic builder materials. Small amounts of calcium carbonate may optionally also be contained in solid textile washing agents. Water-soluble crystalline and/or amorphous alkali silicates are suitable, for example. The alkali silicates that can be used in the agents according to the invention as builders preferably have a molar ratio of alkali oxide to SiO₂ of less than 0.95, in particular of 1:1.1 to 1:12, and may be present in amorphous or crystalline form. Preferred alkali silicates are sodium silicates, in particular amorphous sodium silicates, having a molar ratio of Na₂O:SiO₂ of 1:2 to 1:2.8. As crystalline silicates, which may be present alone or in admixture with amorphous silicates, crystalline phyllosilicates of the general formula Na₂SiₓO₂₊₁·yH₂O are preferably used, in which x, known as the modulus, is a number from 1.9 to 22, in particular 1.9 to 4, and y is a number from 0 to 33, and preferred values for x are 2, 3, or 4. Preferred crystalline phyllosilicates are those in which x assumes the values 2 or 3 in the mentioned general formula. In particular, both β- and δ-sodium disilicates (Na₂Si₂O₅·yH₂O) are preferred. Practically water-free crystalline alkali silicates of the above general formula, in which x is a number from 1.9 to 2.1 and which are produced from amorphous alkali silicates, may also be used in agents according to the invention. In a further embodiment of agents according to the invention, a crystalline sodium phyllosilicate having a modulus of 2 to 3, as can be prepared from sand and soda, is used. Crystalline sodium silicates having a modulus in the range of 1.9 to 3.5 are used in a further embodiment of agents according to the invention. In agents containing amorphous and crystalline alkali silicates, the weight ratio of amorphous alkali silicate to crystalline alkali silicate is preferably from 1:2 to 2:1 and in particular from 1:1 to 2:1. Crystalline phyllosilicates of the above formula (I) are sold by Clariant GmbH under the trade name Na-SKS—for example, Na-SKS-1 (Na₂Si₂₂O₄₅·xH₂O, kenyaite), Na-SKS-2 (Na₂Si₁₄O₂₉·xH₂O, magadiite), Na-SKS-3 (Na₂Si₈O₁₇·xH₂O), or Na-SKS-4 (Na₂Si₄O₉·xH₂O, macatite). Of these, Na-SKS-5 (α-Na₂Si₂O₅), Na-SKS-7 (β-Na₂Si₂O₅, natrosilite), Na-SKS-9 (NaHSi₂O₅·3H₂O), Na-SKS-10 (NaHSi₂O₅·3H₂O, kanemite), Na-SKS-11 (t-Na₂Si₂O₅), and Na-SKS-13 (NaHSi₂O₅), and in particular Na-SKS-6 (δ-Na₂Si₂O₅), are particularly suitable. In one embodiment of agents according to the invention, a granular compound made of crystalline phyllosilicate and citrate, crystalline phyllosilicate and the above-described (co)polymeric polycarboxylic acid, or alkali silicate and alkali carbonate is used, as is commercially available under the name Nabion® 15, for example. Water-soluble inorganic builder materials of this kind are contained in agents according to the invention preferably in amounts of 1 to 20 wt. %, in particular 5 to 15 wt. %. Also of significance as water-soluble inorganic builder substances are the carbonates (and hydrogen carbonates), in particular sodium carbonate, and the phosphonic acids/phosphonates.

The agents according to the invention are preferably free of phosphate builders, i.e., they contain less than 1 wt. %, and preferably no phosphate builders are added intentionally.

The agents can also contain water-insoluble builders. Crystalline or amorphous water-dispersible alkali aluminosilicates, in amounts of up to 50 wt. %, preferably not more than 40 wt. %, in particular of 3 to 20 wt. % and particularly preferably of 1 to 15 wt. %, are used in particular as water-insoluble inorganic builder materials. Among these, the crystalline sodium aluminosilicates in washing agent quality, in particular zeolite A, zeolite P, zeolite MAP, and optionally zeolite X, either alone or in mixtures, e.g., in the form of a co-crystallizate of the zeolites A and X (Vegobond® AX, a commercial product from Condea Augusta S.p.A.), are preferred. Amounts close to the stated upper limit are preferably used in solid, particulate agents. Suitable aluminosilicates have, in particular, no particles having a particle size above 30 μm and preferably consist by at least 80 wt. % of particles having a size below 10 μm. The calcium binding capacity, which can be determined according to DE 2412837 A1, of said aluminosilicates is generally in the range of 100 to 200 mg CaO per gram.

In addition to the previously described builders, polymers having a cleaning action can be contained in the washing agent. The proportion by weight of the polymers with respect to the total weight of washing agents according to the invention is preferably 0.1 to 20 wt. %, more preferably 1.0 to 15 wt. %, and even more preferably 2.0 to 12 wt. %.

Possible peroxygen compounds suitable for use in the agents according to the invention include, in particular, organic peroxy acids or peracid salts of organic acids, such as phthalimidopercaproic acid, perbenzoic acid, or salts of diperdodecanoic diacid, hydrogen peroxide, and inorganic salts giving off hydrogen peroxide under the washing conditions, which salts include perborate, percarbonate, persilicate, and/or persulfates such as caroate, as well as hydrogen peroxide inclusion compounds such as H₂O₂-urea adducts. Hydrogen peroxide can also be produced by means of an enzymatic system, i.e., an oxidase and the substrate thereof. If solid peroxygen compounds are intended to be used, these may be used in the form of powders or granules, which may also be coated in a manner known in principle. The peroxygen compounds can be added to the washing liquor as such or in the form of the agents containing them, which in principle can contain all conventional washing, cleaning, or disinfectant components. Particularly preferably, alkali percarbonate or alkali perborate monohydrate is used. If an agent according to the invention contains peroxygen compounds, these are present in amounts of preferably up to 50 wt. %, in particular of 5 to 30 wt. %, and more preferably of 0.1 to 20 wt. %.

Compounds which, under perhydrolysis conditions, result in aliphatic peroxocarboxylic acids having preferably 1 to 10 C atoms, in particular 2 to 4 C atoms, and/or optionally substituted perbenzoic acid, may be used in the agents as bleach activators. Substances that carry the O-acyl and/or N-acyl groups of the stated number of C atoms and/or optionally substituted benzoyl groups are suitable. Preferred are polyacylated alkylene diamines, in particular tetraacetylethylene diamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenol sulfonates or carboxylates or the sulfonic or carboxylic acids thereof, in particular nonanoyloxybenzene sulfonate or isononanoyloxybenzene sulfonate or laroyloxybenzene sulfonate (NOBS or iso-NOBS or LOBS), 4-(2-decanoyloxyethoxycarbonyloxy)-benzene sulfonate (DECOBS) or decanoyloxybenzoate (DOBA), carboxylic acid anhydrides, in particular phthalic acid anhydride, acylated polyhydric alcohols, in particular triacetin, ethylene glycol diacetate, 2,5-diacetoxy-2,5-dihydrofuran, and enol esters, as well as acetylated sorbitol and mannitol or the described mixtures thereof (SORMAN), acylated sugar derivatives, in particular pentaacetyl glucose (PAG), pentaacetyl fructose, tetraacetylxylose, and octaacetyl lactose, acetylated, optionally N-alkylated glucamine and gluconolactone, N-acylated lactams, e.g., N-benzoylcaprolactam, nitriles from which perimidic acids are formed, in particular aminoacetonitrile derivatives having a quaternized nitrogen atom, and/or oxygen-transferring sulfonimines and/or acylhydrazones. The hydrophilically substituted acyl acetals and the acyl lactams are likewise preferably used. Combinations of conventional bleach activators can also be used. Such bleach activators can, in particular in the presence of the above-mentioned hydrogen peroxide-yielding bleaching agents, be present in the customary quantity range, preferably in amounts of 0.5 to 10 wt. %, and in particular 1 to 8 wt. %, relative to the total agent, but are preferably entirely absent when percarboxylic acid is used as the sole bleaching agent.

In addition to or instead of the conventional bleach activators, sulfonimines and/or bleach-boosting transition metal salts or transition metal complexes may also be contained in solid agents as what are referred to as bleach catalysts.

Suitable graying inhibitors or soil release active ingredients (soil release polymer) are cellulose ethers, such as carboxymethyl cellulose, methyl cellulose, hydroxyalkyl celluloses and mixed cellulose ethers, such as methyl hydroxyethyl cellulose, methylhydroxypropyl cellulose, and methyl carboxymethyl cellulose. Sodium carboxymethyl cellulose, hydroxypropyl methyl cellulose and mixtures thereof and, optionally, mixtures thereof with methyl cellulose are preferably used. The soil release active ingredients commonly used include copolyesters which contain dicarboxylic acid units, alkylene glycol units, and polyalkylene glycol units. The proportion of graying inhibitors and/or soil release active ingredients in agents according to the invention is generally no greater than 2 wt. % and is preferably 0.5 to 1.5 wt. %, particularly preferably 0.5 to 2 wt. %.

Derivatives of diaminostilbene disulfonic acid or the alkali metal salts thereof can be contained, for example, as optical brighteners, in particular for textiles made of cellulose fibers (e.g., cotton). Salts of 4,4′-bis(2-anilino-4-morpholino-1,3,5-triazinyl-6-amino)stilbene-2,2′-disulfonic acid or compounds having a similar structure which, instead of the morpholino group, have a diethanolamino group, a methylamino group, or a 2-methoxyethylamino group are suitable, for example. Furthermore, brighteners of the substituted 4,4′-distyryl-diphenyl type can be present, e.g., 4,4′-bis-(4-chloro-3-sulfostyryl)-diphenyl. Mixtures of brighteners can also be used. Brighteners of the 1,3-diaryl-2-pyrazoline type, e.g., 1-(p-sulfoamoylphenyl)-3-(p-chlorophenyl)-2-pyrazoline, and compounds having a similar structure are particularly suitable for polyamide fibers. The content of optical brighteners or brightener mixtures in the agent is generally no greater than 1 wt. %, preferably 0.05 to 0.5 wt. %. In a preferred embodiment of the invention, the agent is free of such active ingredients.

The customary foam regulators that can be used in the agents according to the invention include, for example, polysiloxane-silicic acid mixtures, the finely divided silicic acid contained therein preferably being silanized or otherwise hydrophobized. The polysiloxanes can consist of both linear compounds and crosslinked polysiloxane resins and mixtures thereof. Further defoamers are paraffinic hydrocarbons, in particular microparaffins and paraffin waxes of which the melting point is above 40° C., saturated fatty acids or soaps having in particular 20 to 22 C atoms, e.g., sodium behenate, and alkali salts of phosphoric acid mono- and/or dialkyl esters, in which the alkyl chains each have 12 to 22 C atoms. Among these, sodium monoalkyl phosphate and/or dialkyl phosphate having C₁₆₋₁₈ alkyl groups is preferably used. The proportion of foam regulators can preferably be 0.2 to 2 wt. %, particularly preferably not more than 1 wt. %.

In order to set the desired pH, the agents according to the invention can contain acids that are compatible with the system and environment, in particular citric acid, acetic acid, tartaric acid, malic acid, lactic acid, glycolic acid, succinic acid, glutaric acid, and/or adipic acid, but also mineral acids, in particular sulfuric acid or alkali hydrogen sulfates, or bases, in particular ammonium or alkali hydroxides, preferably sodium hydroxide. These types of pH regulators are contained in the agents according to the invention in amounts preferably no greater than 10 wt. %, in particular of 0.5 to 6 wt. %, particularly preferably of 0.3 to 2 wt. %.

The washing agents according to the invention can contain an organic solvent as a further component. Adding organic solvents has an advantageous effect on the enzyme stability and cleaning performance of these agents. Preferred organic solvents are derived from the group of monohydric or polyhydric alcohols, alkanolamines or glycol ethers. The solvents are preferably selected from ethanol, n- or i-propanol, butanol, glycol, propanediol, butanediol, glycerol, diglycol, propylene diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol methyl ether, dipropylene glycol ethyl ether, methoxytriglycol, ethoxytriglycol, butoxytriglycol, 1-butoxyethoxy-2-propanol, 3-methyl-3-methoxybutanol, propylene-glycol-t-butyl ether, and mixtures of these solvents. The proportion by weight of these organic solvents with respect to the total weight of the washing agents according to the invention is preferably 0.1 to 10 wt. %, more preferably 0.2 to 8.0 wt. %, and even more preferably 0.5 to 5.0 wt. %. A particularly preferred organic solvent which is particularly effective in stabilizing the washing agents is glycerol, as well as 1,2-propylene glycol. Liquid washing agents preferably comprise at least one polyol, preferably from the group glycerol and 1,2-propylene glycol, relative to the total weight of the washing agent, preferably in an amount of 0.1 to 10 wt. %, preferably 0.2 to 8.0 wt. %, and more preferably 0.5 to 5.0 wt. %. Other preferred organic solvents are the organic amines and alkanolamines. The washing agents according to the invention preferably contain these amines in amounts of 0.1 to 10 wt. %, more preferably of 0.2 to 8.0 wt. %, and even more preferably of 0.5 to 5.0 wt. %, in each case relative to the total weight thereof. Ethanolamine is a particularly preferred alkanolamine.

Washing or cleaning agents according to the invention can contain only one protease. Alternatively, they can also contain further hydrolytic enzymes or other enzymes in a concentration expedient for the effectiveness of the agent. A further embodiment of the invention is thus represented by agents that further comprise one or more further enzymes. Further enzymes which can preferably be used are all enzymes which can exhibit catalytic activity in the agent according to the invention, in particular a lipase, amylase, cellulase, hemicellulase, mannanase, tannase, xylanase, xanthanase, xytoglucanase, β-glucosidase, pectinase, carrageenase, perhydrolase, oxidase, oxidoreductase, or another protease, which is different from the proteases according to the invention, as well as mixtures thereof. Further enzymes are advantageously contained in the agent in each case in an amount of 1×10⁻⁸ to 5 wt. %, based upon the active protein. Increasingly preferably, each further enzyme is contained in agents according to the invention in an amount of 1×10⁻⁷ to 3 wt. %, of 0.00001 to 1 wt. %, of 0.00005 to 0.5 wt. %, of 0.0001 to 0.1 wt. %, and particularly preferably of 0.0001 to 0.05 wt. %, based upon active protein. Particularly preferably, the enzymes exhibit synergistic cleaning performance with respect to particular dirt or stains, i.e., the enzymes contained in the agent composition assist one another in their cleaning performance. Synergism of this kind is very particularly preferably present between the protease contained according to the invention and a further enzyme of an agent according to the invention, including in particular between said protease and an amylase and/or a lipase and/or a mannanase and/or a cellulase and/or a pectinase. Synergistic effects can occur not only between different enzymes, but also between one or more enzymes and other ingredients of the agent according to the invention.

Textile washing agents preferred according to the invention have at least one protease and at least one amylase. In a further preferred embodiment of the invention, textile washing agents have at least one protease and at least one cellulase. In a further preferred embodiment, textile washing agents have at least one protease, and at least one lipase. In a further preferred embodiment, textile washing agents have at least one protease, at least one amylase, and at least one lipase. In a further preferred embodiment, textile washing agents have at least one protease, at least one amylase, and at least one cellulase. In a further preferred embodiment, textile washing agents have at least one protease, at least one amylase, at least one cellulase, and at least one lipase. Textile washing agents which have 3 to 10 different enzymes are particularly preferred, it being possible for textile washing agents which have 3 to 10 different types of enzymes to be particularly preferred with regard to the cleaning performance over a very broad spectrum of stains.

Examples of proteases are the subtilisins BPN′ from Bacillus amyloliquefaciens and Carlsberg from Bacillus licheniformis, protease PB92, subtilisins 147 and 309, the protease from Bacillus lentus, subtilisin DY, and the enzymes thermitase, proteinase K, and proteases TW3 and TW7, which in the narrower sense are associated with the subtilases but no longer with the subtilisins. Subtilisin Carlsberg is available in a developed form under the trade name Alcalase® from Novozymes. Subtilisins 147 and 309 are marketed by Novozymes under the trade names Esperase® and Savinase®, respectively. The protease variants are derived from the protease from Bacillus lentus DSM 5483. Other proteases that are suitable are, for example, the enzymes available under the trade names Durazym®, Relase®, Everlase®, Nafizym®, Natalase®, Kannase®, Progress Uno 101L®, and Ovozyme® from Novozymes, the enzymes available under the trade names Purafect®, Purafect® OxP, Purafect® Prime, Excellase® and Properase®, Preferenz P100® and Preferenz P300® from Danisco/DuPont, the enzyme available under the trade name Lavergy pro 104 LS® from BASF, the enzyme available under the trade name Protosol® from Advanced Biochemicals Ltd., the enzyme available under the trade name Wuxi® from Wuxi Snyder Bioproducts Ltd., the enzymes available under the trade names Proleather® and Protease P® from Amano Pharmaceuticals Ltd., and the enzyme available under the name Proteinase K-16 from Kao Corp. The proteases from Bacillus gibsonii and Bacillus pumilus, which are disclosed in WO 2008/086916, WO 2007/131656, WO 2017/215925, WO 2021/175696, and WO 2021/175697, are particularly preferably used. Further proteases which can be used advantageously are disclosed in, for example, WO 91/02792, WO 2008/007319, WO 93/18140, WO 01/44452, GB 1243784 A, WO 96/34946, WO 02/029024, and WO 03/057246. Further proteases that can be used are those which are naturally present in the microorganisms Stenotrophomonas maltophilia, in particular Stenotrophomonas maltophilia K279a, Bacillus intermedius, and Bacillus sphaericus.

Examples of amylases are the α-amylases from Bacillus licheniformis, Bacillus amyloliquefaciens, or Bacillus stearothermophilus, as well as in particular the developments thereof that have been improved for use in washing or cleaning agents. The enzyme from Bacillus licheniformis is available from Novozymes under the name Termamyl® and from Danisco/DuPont under the name Purastar® ST. Development products of this α-amylase are available under the trade names Duramyl® and Termamyl® ultra (both from Novozymes), Purastar® OxAm (Danisco/DuPont), and Keistase® (Daiwa Seiko Inc.). The α-amylase from Bacillus amyloliquefaciens is marketed by Novozymes under the name BAN®, and derived variants from the α-amylase from Bacillus stearothermophilus are marketed under the names BSG® and Novamyl®, also by Novozymes. Others that are particularly noteworthy for this purpose are the α-amylases from Bacillus sp. A 7-7 (DSM 12368), and the cyclodextrin glucanotransferase (CGTase) from Bacillus agaradherens (DSM 9948) should be emphasized. Furthermore, the amylolytic enzymes which are disclosed in WO 95/26397, WO 96/23873, WO 99/23211, WO 00/60060, WO 2003/002711, WO 2003/054177, WO 2006/002643, WO 2007/079938, WO 2011/100410, and WO 2013/003659 can be used. Fusion products of all mentioned molecules can also be used. Furthermore, the developments of the α-amylase from Aspergillus niger and A. oryzae, available under the trade name Fungamyl® from Novozymes, are suitable. Other commercial products that can be advantageously used are, for example, Amylase-LT® and Stainzyme® or Stainzyme® ultra or Stainzyme® plus as well as Amplify™ 12L or Amplify Prime™ 100L, the latter also from Novozymes, and the PREFERENZ S® series from Danisco/DuPont, including, for example, PREFERENCE S100®, PREFERENCE S1000®, or PREFERENCE S210®. Variants of these enzymes that can be obtained by point mutations may also be used according to the invention.

### Preferred Amylases Include

a) an α-amylase which comprises an amino acid sequence which is at least 80% and increasing preferably at least 81%, 82%, 83%, 84%, 85%, 86%, 87%, 88%, 89%, 90%, 91%, 92%, 93%, 94%, 95%, 96%, 97%, 98%, or 99% identical to the amino acid sequence specified in SEQ ID NO:13 over the entire length thereof and optionally has at least one amino acid substitution at one of the positions 172, 202, 208, 255, and 261 in the numbering according to SEQ ID NO:13, preferably selected from the group consisting of M202L, M202V, M202S, M202T, M202I, M202Q, M202W, S255N, R172Q, and combinations thereof; and/or
b) an α-amylase comprising an amino acid sequence which is at least 60% and increasingly preferably at least 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 92%, 93%, 94%, 95%, 96%, 97%, 98%, or 99% identical to the amino acid sequence specified in SEQ ID NO:14 over the entire length thereof, and optionally has at least one amino acid substitution at one of positions 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484 and/or a deletion at one of positions 183 and 184 in the numbering according to SEQ ID NO:14, preferably at least one amino acid substitution at one of positions 9, 26, 149, 182, 186, 202, 257, 295, 299, 323, 339, and 345, and/or particularly preferably at least one amino acid substitution or deletion selected from the group consisting of R118K, D183*, G184*, N195F, R320K, R458K, and combinations thereof; and/or
c) an α-amylase comprising an amino acid sequence which is at least 65% and increasingly preferably at least 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 92%, 93%, 94%, 95%, 96%, 97%, 98%, or 99% identical to the amino acid sequence specified in SEQ ID NO:15 over the entire length thereof, and optionally has at least one substitution and/or deletion at one of positions 93, 116, 118, 129, 133, 134, 140, 142, 146, 147, 149, 151, 152, 169, 174, 183, 184, 186, 189, 193, 195, 197, 198, 200, 203, 206, 210, 212, 213, 235, 243, 244, 260, 262, 284, 303, 304, 320, 338, 347, 359, 418, 431, 434, 439, 447, 458, 469, 476, and 477 in the numbering according to SEQ ID NO:15, preferably amino acid deletions at the positions 183 and 184; and/or
d) an α-amylase which comprises an amino acid sequence which is at least 89% and increasingly preferably at least 90%, 91%, 92%, 93%, 94%, 95%, 96%, 97%, 98%, or 99% identical to the amino acid sequence specified in SEQ ID NO:16 over the entire length thereof and has at least one deletion at one of the positions 180, 181, 182, 183, and 184 in the numbering according to SEQ ID NO:16, preferably deletions at at least two positions selected from the positions 180+181, 181+182, 182+183, and 183+184 in the numbering according to SEQ ID NO:16, and particularly preferably at the positions 183+184 in the numbering according to SEQ ID NO:16, and/or has at least one substitution at one of the positions 405, 421, 422, and 428 in the numbering according to SEQ ID NO:16, selected from the group consisting of I405L, A421H, A422P, A428T, and combinations thereof.

In various embodiments of the invention, the amylase comprises an amino acid sequence which is at least 80% and increasingly preferably at least 81%, 82, 83%, 84%, 85%, 86%, 87%, 88%, 89%, 90%, 91%, 92%, 93%, 94%, 95%, 96%, 97%, 98%, or 99% identical to the amino acid sequence given in SEQ ID NO:13 over its entire length and has at least one amino acid substitution at one of the positions 172, 202, 208, 255, and 261 in the numbering according to SEQ ID NO:13, preferably selected from the group consisting of M202L, M202V, M202S, M202T, M202I, M202Q, M202W, S255N, R172Q, and combinations thereof. Amylases are preferably used which have an amino acid substitution at two, preferably three, of the above-mentioned positions, in particular a substitution at position 202 selected from M202L, M202V, M202S, M202T, M202I, M202Q, M202W, a substitution at position 255, in particular S255N, and a substitution at position 172, in particular R172Q. The M202L and M202T mutants are very particularly preferred.

In various embodiments of the invention, the amylase comprises an amino acid sequence which is at least 60% and increasingly preferably at least 61%, 62%, 63%, 64%, 65%, 66%, 67%, 68%, 69%, 79%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 92%, 93%, 94%, 95%, 96%, 97%, 98%, or 99% identical to the amino acid sequence specified in SEQ ID NO:14 over the entire length thereof, and optionally has at least one amino acid substitution at one of positions 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484 and/or a deletion at one of positions 183 and 184 in the numbering according to SEQ ID NO:14, preferably at least one amino acid substitution at one of positions 9, 26, 149, 182, 186, 202, 257, 295, 299, 323, 339, and 345, and particularly preferably selected from the group consisting of R118K, D183*, G184*, N195F, R320K, R458K, and combinations thereof. In various preferred embodiments, the amylase in the numbering according to SEQ ID NO:14 has amino acid substitutions at three or more of the positions 9, 26, 149, 182, 186, 202, 257, 295, 299, 323, 339, and 345 and optionally one or more, preferably all, of the substitutions and/or deletions at the positions: 118, 183, 184, 195, 320, and 458, and particularly preferably R118K, D183*, G184*, N195F, R320K, and/or R458K. In particularly preferred embodiments, the amylase comprises, in the numbering according to SEQ ID NO:14, the following amino acid substitutions and/or deletions: M9L-M323T; M9L-M202L/T/V/I-M323T; M9L-N195F-M202L/T/V/I-M323T; M9L-R118K-D183*-G184*-R320K-M323T-R458K; M9L-R118K-D183*-G184*-M202L/T/V/I-R320K-M323T-R458K; M9L-G149A-G182T-G186A-M202L-T257I-Y295F-N299Y-M323T-A339S-E345R; M9L-G149A-G182T-G186A-M202I-T257I-Y295F-N299Y-M323T-A339S-E345R; M9L-R118K-G149A-G182T-D183*-G184*-G186A-M202L-T257I-Y295F-N299Y-R320K-M323T-A339S-E345R-R458K; M9L-R118K-G149A-G182T-D183*-G184*-G186A-N195F-M202L-T257I-Y295F-N299Y-R320K-M323T-A339S-E345R-R458K; M9L-R118K-G149A-G182T-D183*-G184*-G186A-M202I-T257I-Y295F-N299Y-R320K-M323T-A339S-E345R-R458K; M9L-R118K-D183*-D184*-N195F-M202L-R320K-M323T-R458K; M9L-R118K-D183*-D184*-N195F-M202T-R320K-M323T-R458K; M9L-R118K-D183*-D184*-N195F-M202I-R320K-M323T-R458K; M9L-R118K-D183*-D184*-N195F-M202V-R320K-M323T-R458K; M9L-R118K-N150H-D183*-D184*-N195F-M202L-V214T-R320K-M323T-R458K; or M9L-R118K-D183*-D184*-N195F-M202L-V214T-R320K-M323T-E345N-R458K.

In various embodiments of the invention, the amylase comprises an amino acid sequence which is at least 65% and increasingly preferably at least 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% identical to the amino acid sequence specified in SEQ ID NO:15 over the entire length thereof, and optionally has at least one substitution and/or deletion at one of positions 93, 116, 118, 129, 133, 134, 140, 142, 146, 147, 149, 151, 152, 169, 174, 183, 184, 186, 189, 193, 195, 197, 198, 200, 203, 206, 210, 212, 213, 235, 243, 244, 260, 262, 284, 303, 304, 320, 338, 347, 359, 418, 431, 434, 439, 447, 458, 469, 476, and 477 in the numbering according to SEQ ID NO:15. Preferred amino acid substitutions in this regard comprise E260A/D/C/Q/L/M/F/P/S/W/V/G/H/I/K/N/R/T/Y, G304R/K/E/Q, W140Y/F, W189E/G/T, D134E, F262G/P, W284D/H/F/Y/R, W347H/F/Y, W439R/G, G476E/Q/R/K, G477E/Q/K/M/R, N195F/Y, N197F/L, Y198N, Y200F, Y203F, I206H/L/N/F/Y, H210Y, E212V/G, V213A, M116T, Q129L, G133E, E134Y, K142R, P146S, G147E, G149R, N151R, Y152H, Q169E, N174R, A186R, Y243F, S244Q, G303V, R320N, R3591, N418D, and A447V.

In various embodiments of the invention, the amylase comprises an amino acid sequence which is at least 89% and increasingly preferably at least 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, or 99% identical to the sequence specified in SEQ ID NO:16 over the entire length thereof and has a deletion at one or more of the positions 180, 181, 182, 183, and 184 in the numbering according to SEQ ID NO:16. Particularly preferred is a deletion of two positions selected from 180+181, 181+182, 182+183, and 183+184, and very particularly preferred are the deletions at positions 183+184 in the numbering according to SEQ ID NO:16, and the deletions H183*+G184* are preferred in particular. Preferably, such an α-amylase also has an amino acid substitution at one or more of the positions 405, 421, 422, and 428 in the numbering according to SEQ ID NO:16. One or more of the substitutions I405L, A421H, A422P, and A428T are particularly preferred. In a particularly preferred embodiment, the α-amylase has the deletions H183*+G184* and additionally the substitutions I405L, A421H, A422P, and A428T in the numbering according to SEQ ID NO:16.

The term “cellulase” as used herein refers to an enzyme that catalyzes the hydrolysis of 1,4-β-D-glucoside bonds in cellulose (cellobiose), and/or lichenin and/or β-D-glucans. They are often also able to hydrolyze the 1,4-bonds in β-D-glucans, which also have 1,3-bonds in addition to the 1,4-bonds. Cellulases are able to break down cellulose to β-glucose. Consequently, cellulases act in particular upon cellulose-containing or cellulose derivative-containing functional groups and catalyze their hydrolysis. In a preferred embodiment of the invention, the cellulase is an endoglucanase (EC 3.2.1.4). Synonymous terms can be used for cellulases, in particular endoglucanase, endo-1,4-β-glucanase, carboxymethyl cellulase, endo-1,4-β-D-glucanase, β-1,4-glucanase, β-1,4-endoglucanhydrolase, celludextrinase, or avicelase. The determining factor as to whether an enzyme is a cellulase in the context of the invention is its ability to hydrolyze 1,4-β-D-glucoside bonds in cellulose.

The term “cellulase activity” is defined here as an enzyme that catalyzes the hydrolysis of 1,4-β-D-glucoside bonds into β-1,4-glucan (cellulose). Cellulose activity is measured using a standard method, e.g., as follows: Cellulases release glucose from CMC (carboxymethylcellulose). The samples are incubated under defined reaction conditions (100 mM sodium phosphate buffer pH 7.5, 40° C., 15 min) with a substrate (1.25% CMC). The reaction with p-hydroxybenzoic acid hydrazide (PAHBAH) in the presence of bismuth produces a yellow dye that can be determined photometrically at 410 nm. The prerequisite is an alkaline pH during the color reaction. The amount of sugar released corresponding to the coloration is a measure of enzyme activity (Lever, Anal. Biochem., 1972, 47 & 1977, 81).

Suitable cellulases include those of bacterial or fungal origin. Chemically modified or protein-engineered mutants are included. Suitable cellulases are cellulases from the genera Bacillus, Pseudomonas, Humicola, Fusarium, Thielvia, Acremonium, e.g., the fungal cellulase from Humicola insolens, Mycelophthora thermophila, and Fusarium oxysporum, which are disclosed in U.S. Pat. Nos. 4,435,307, 5,648,263, 5,691,178, 5,776,757, and WO 89/09259. Particularly suitable cellulases are the alkaline or neutral cellulases with color care properties. Examples of such cellulases are cellulases which are described in EP 0495257, EP 0531372, WO 96/11262, WO 96/29397, and WO 98/08940. Other examples are cellulase variants as described in WO 94/07998, EP 0531315, EP 3212777, EP 3502243, EP 3653705, EP 3653706, U.S. Pat. Nos. 5,457,046, 5,686,593, 5,763,254, WO 95/24471, WO 98/12307 and WO 99/01544, and WO 2019/122520.

Examples of cellulases with endo-1,4-glucanase activity (EC 3.2.1.4) are described in WO 2002/099091—for example, those having a sequence of at least 97% identity to the amino acid sequence of positions 1 to 773 of SEQ ID NO:2 of WO 2002/099091. A further example can comprise a GH44-xyloglucanase—for example, a xyloglucanase enzyme having a sequence of at least 60% identity to positions 40 to 559 of SEQ ID NO:2 of WO 2001/062903.

Other examples of cellulases include the GH45 cellulases described in WO 96/29397 and, in particular, variants thereof having substitution, insertion, and/or deletion at one or more of the positions corresponding to the following positions in SEQ ID NO:8 of WO 2002/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected from P19A, G20K, Q44K, N48E, Q119H, or Q146R.

Commercially available cellulases include Celluzyme™, Carezyme™, Carezyme Premium™, Celluclean™ (e.g., Celluclean™ 5000L and Celluclean™ 4000T), Celluclean Classic™, Cellusoft™, Endolase®, Renozyme® and Whitezyme™ (Novozymes A/S), Clazinase™ and Puradax HA™ (Genencor International Inc.), KAC-500(B)™ (Kao Corporation), Revitalenz™ 1000, Revitalenz™ 2000 and Revitalenz™ 3000 (DuPont), as well as Ecostone® and Biotouch® (AB Enzymes).

Further enzymes that can be used are, for example, lipases or cutinases, in particular for the triglyceride-cleaving activities thereof, but also so as to create peroxy acids in situ from suitable precursors.

Suitable lipases and cutinases are those of bacterial or fungal origin. Chemically modified mutated enzymes generated by protein engineering are included. Examples are lipase from Thermomyces, e.g., from T. lanuginosus (formerly called Humicola lanuginosa), as described in EP 0258068 and EP 0305216, cutinase from Humicola, e.g., H. insolens (WO 96/13580), lipase from strains of Pseudomonas (some of these now renamed Burkholderia), e.g., P. alcaligenes or P. pseudoalcaligenes (EP 0218272), P. cephalia (EP 0331376), P. sp. strain SD705 (WO 95/06720 & WO 96/27002), P. wisconsinensis (WO 96/12012), Streptomyces lipases of the GDSL type (WO 2010/065455), cutinase from Magnaporthe grisea (WO 2010/107560), cutinase from Pseudomonas mendocina (U.S. Pat. No. 5,389,536), lipase from Thermobifida fusca (WO 2011/084412), lipase from Geobacillus stearothermophilus (WO 2011/084417), lipase from Bacillus subtilis (WO 2011/084599), and lipase from Streptomyces griseus (WO 2011/150157) and S. pristinaespiralis (WO 2012/137147).

The lipases that can originally be obtained from Humicola lanuginosa (Thermomyces lanuginosus) or have been developed therefrom, in particular those having one or more of the following amino acid exchanges in positions D96L, T213R, and/or N233R, particularly preferably T213R and N233R, proceeding from the mentioned lipase, belong to the preferred lipases. Lipases are marketed, for example, by Novozymes under the trade names Lipolase®, Lipolase® Ultra, LipoPrime®, Lipozyme®, and Lipex®. Another lipase that can be used advantageously is available from Novozymes under the trade name Lipoclean®.

Moreover, the cutinases which have been originally isolated from Fusarium solani pisi and Humicola insolens can also be used, for example. Lipases that are also suitable are available from Amano under the names Lipase CE®, Lipase P®, Lipase B® or Lipase CES®, Lipase AKG®, Bacillus sp. Lipase®, Lipase AP®, Lipase M-AP®, and Lipase AML®. From Danisco/DuPont, for example, lipases or cutinases can be used of which the starting enzymes were originally isolated from Pseudomonas mendocina and Fusarium solanii. The preparations M1 Lipase® and Lipomax® marketed by Danisco/Genencor, the enzymes marketed by Meito Sangyo KK, under the names Lipase MY-30®, Lipase OF®, and Lipase PL®, and the product Lumafast® from Danisco/DuPont should be mentioned as other important commercial products.

Further examples are lipases, which are also referred to as acyltransferases or perhydrolases, e.g., acyltransferases with homology to Candida antarctica lipase A (WO 2010/111143), acyltransferase from Mycobacterium smegmatis (WO 2005/056782), perhydrolases from the CE 7 family (WO 2009/067279), and variants of M. smegmatis perhydrolase, in particular the S54V variant used in the commercial product Gentle Power Bleach from Huntsman Textile Effects Pte Ltd (WO 2010/100028). Further examples are lipase variants as described in EP 0407225, WO 92/05249, WO 94/01541, WO 94/25578, WO 95/14783, WO 95/30744, WO 95/35381, WO 95/22615, WO 96/00292, WO 97/04079, WO 97/07202, WO 2000/034450, WO 2000/060063, WO 2001/092502, WO 2007/087508, and WO 2009/109500.

Preferred commercial lipase products include Lipolase™, Lipex™, Lipolex™, and Lipoclean™ (Novozymes A/S), Lumafast (Genencor/DuPont), and Lipomax (Gist-Brocades).

In order to increase the bleaching effect, oxidoreductases, such as oxidases, oxygenases, catalases, peroxidases, such as halo, chloro, bromo, lignin, glucose, or manganese peroxidases, dioxygenases, or laccases (phenoloxidases, polyphenoloxidases) can be used according to the invention. Advantageously, organic, particularly preferably aromatic compounds that interact with the enzymes are additionally added in order to potentiate the activity of the relevant oxidoreductases (enhancers) or, in the event of greatly differing redox potentials, to ensure the flow of electrons between the oxidizing enzymes and the stains (mediators).

In the cleaning agents described herein, the enzymes to be used can further be formulated together with accompanying substances—for example, from fermentation. In liquid formulations, the enzymes are preferably used as liquid enzyme formulation(s).

The enzymes are generally not provided in the form of the pure protein, but rather in the form of stabilized, storable, and transportable preparations. These ready-made preparations include, for example, the solid preparations obtained by means of granulation, extrusion, or lyophilization or, in particular in the case of liquid or gel agents, solutions of the enzymes, which are advantageously as concentrated as possible, have a low water content, and/or are admixed with stabilizers or further auxiliaries.

Alternatively, the enzymes can be encapsulated both for the solid and for the liquid administration form, e.g., by means of spray-drying or extrusion of the enzyme solution together with a preferably natural polymer or in the form of capsules—for example, those in which the enzymes are enclosed as in a solidified gel, or in those of the core-shell type, in which an enzyme-containing core is coated with a protective layer that is impermeable to water, air, and/or chemicals. Further active ingredients, e.g., stabilizers, emulsifiers, pigments, bleaches, or dyes can additionally be applied in overlaid layers. Such capsules are made using methods that are known per se—for example, by means of vibratory granulation or roll granulation or by means of fluid bed processes. Advantageously, such granules are low in dust—for example, due to the application of polymeric film formers—and are stable in storage due to the coating.

Furthermore, it is possible to formulate two or more enzymes together such that a single granule exhibits a plurality of enzyme activities.

The enzymes can also be introduced into water-soluble films, such as those used in the formulation of washing and cleaning agents in a unit dosage form. Such a film allows the enzymes to be released after contact with water. As used herein, “water-soluble” refers to a film structure that is preferably completely water soluble. Preferably, such a film consists of (completely or partially hydrolyzed) polyvinyl alcohol (PVA).

The invention also relates to a method for cleaning textiles or hard surfaces, which is characterized in that an agent according to the invention is used in at least one method step. In various embodiments, the method described above is characterized in that the protease is used at a temperature of 0° C. to 100° C., preferably 20° C. to 60° C., more preferably 20° C. to 40° C., and most preferably at 30° C.

This includes both manual and machine methods, with machine methods being preferred because they can be controlled more precisely—for example, with regard to the quantities used and contact times. Methods for cleaning textiles are generally characterized by the fact that, in a plurality of method steps, various cleaning-active substances are applied to the material to be cleaned and washed off after the exposure time, or in that the material to be cleaned is otherwise treated with a washing agent or a solution or dilution of this agent.

All aspects, subject matter, and embodiments described for the protease according to the invention and agents containing them are also applicable to this subject matter of the invention. Therefore, reference is expressly made at this point to the disclosure at the corresponding point, with the note that this disclosure also applies to the above methods according to the invention.

A further object of the invention is the use of a peptide (peptidic inhibitor) for improving the stability, in particular the storage stability, of proteases in a washing and cleaning agent, wherein the peptide has an amino acid sequence which is at least 90% and increasingly preferably at least 91%, 92%, 93%, 94%, 95%, 96%, 97%, 98%, 99%, or 100% identical to an amino acid sequence selected from the sequence consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

A further object of the invention is the use of a peptide (peptidic inhibitor) for preventing and/or reducing the autoproteolysis of a protease contained in the washing and cleaning agent, wherein the peptide has an amino acid sequence which is at least 90% and increasingly preferably at least 91%, 92%, 93%, 94%, 95%, 96%, 97%, 98%, 99%, or 100% identical to an amino acid sequence selected from the sequence consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

All aspects, subject matter, and embodiments described for the protease according to the invention and agents containing them are also applicable to this subject matter of the invention. Therefore, reference is expressly made at this point to the disclosure at the corresponding point with the note that this disclosure also applies to the above use according to the invention.

### PREFERRED EMBODIMENTS

1. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence that is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

2. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the washing and cleaning agent is substantially free of boron-containing compounds, and preferably free of boron-containing compounds.

3. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

4. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the washing and cleaning agent is substantially free of boron-containing compounds, and preferably free of boron-containing compounds, and wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

5. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptide having an amino acid sequence that is at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length.

6. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptide having an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably SEQ ID NO:2, SEQ ID NO:4, SEQ ID NO:5, SEQ ID NO:8, or SEQ ID NO:11, wherein the washing and cleaning agent is substantially free of boron-containing compounds, and preferably free of boron-containing compounds.

7. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptide having an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably SEQ ID NO:2, SEQ ID NO:4, SEQ ID NO:5, SEQ ID NO:8, or SEQ ID NO:11, wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

8. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptide having an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably SEQ ID NO:2, SEQ ID NO:4, SEQ ID NO:5, SEQ ID NO:8, or SEQ ID NO:11, wherein the washing and cleaning agent is substantially free of boron-containing compounds, and preferably free of boron-containing compounds, and wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

9. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the protease after storage (as described in example 2) has a residual activity increased by a factor of at least 1.1 to 2.5, preferably 1.2 to 2.0, and more preferably 1.3 to 1.9, when the protease is stored together with the peptide.

10. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the protease after storage (as described in example 2) has a residual activity increased by a factor of at least 1.1 to 2.5, preferably 1.2 to 2.0, and more preferably 1.3 to 1.9, when the protease is stored together with the peptide, wherein the washing and cleaning agent is substantially free of boron-containing compounds, and preferably free of boron-containing compounds.

11. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, wherein the protease after storage (as described in example 2) has a residual activity increased by a factor of at least 1.1 to 2.5, preferably 1.2 to 2.0, and more preferably 1.3 to 1.9, when the protease is stored together with the peptide, wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

12. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptide having an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length,
wherein the protease after storage (as described in example 2) has a residual activity increased by a factor of at least 1.1 to 2.5, preferably 1.2 to 2.0, and more preferably 1.3 to 1.9, when the protease is stored together with the peptide,
wherein the washing and cleaning agent is substantially free of boron-containing compounds, and preferably free of boron-containing compounds, and
wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

13. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20.

14. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20, wherein the washing and cleaning agent is substantially free of boron-containing compounds, and preferably free of boron-containing compounds.

15. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20, wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

16. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 189T, 211N, and 224A,
b) at least one peptidic inhibitor which has an initial inhibitory power of at least 2.5 to 50, preferably 5 to 40, preferably 10 to 30, and more preferably 12.5 to 20, wherein the washing and cleaning agent is substantially free of boron-containing compounds, and preferably free of boron-containing compounds, and wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

17. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptidic inhibitor which has an initial inhibitory power of at least 2.5 to 50, preferably 5 to 40, preferably 10 to 30, and more preferably 12.5 to 20.

18. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptidic inhibitor which has an initial inhibitory power of at least 2.5 to 50, preferably 5 to 40, preferably 10 to 30, and more preferably 12.5 to 20, wherein the washing and cleaning agent is substantially free of boron-containing compounds, and preferably free of boron-containing compounds.

19. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptidic inhibitor which has an initial inhibitory power of at least 2.5 to 50, preferably 5 to 40, preferably 10 to 30, and more preferably 12.5 to 20, wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

20. A washing and cleaning agent, in particular, liquid washing and cleaning agent, and particularly preferably liquid textile washing agent, comprising
a) at least one protease which exhibits proteolytic activity and has one of the following amino acid substitution variants, in each case based upon the numbering according to SEQ ID NO:1: (i) P9T-N130D-T133A-N144K-G166M-S189T-Y217M-N252T-Q271E; (ii) P9T-N130D-T133A-N144K-G166M-S189T-Y217M-S224A-N252T-Q271E; (iii) P9T-S89A-N130D-G131H-T133A-N144K-S189T-Y217M-S224A-N252T-Q271E; (iv) Y6W-P9T-N130D-T133A-N144K-S189T-Y217M-S224A-N252T-Q271E; (v) P9T-N130D-T133A-N144K-G166M-S211N-Y217M-N252T-Q271E; (vi) P9T-S89A-N130D-T133A-N144K-S189T-Y217M-S224A-N252T-Q271E; (vii) P9T-S89A-N130D-T133A-N144K-N187D-Y217M-S224A-N252T-Q271E; (viii) P9T-S89A-N130D-T133A-N144K-S189R-Y217M-S224A-N252T-Q271E; (ix) P9T-S89A-N130D-T133A-N144K-N187D-S189R-Y217M-S224A-N252T-Q271E, and
b) at least one peptidic inhibitor which has an initial inhibitory power of at least 2.5 to 50, preferably 5 to 40, preferably 10 to 30, and more preferably 12.5 to 20, wherein the washing and cleaning agent is substantially free of boron-containing compounds, and preferably free of boron-containing compounds, and wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

21. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20,
wherein the protease after storage (as described in example 2) has a residual activity increased by a factor of at least 1.1 to 2.5, preferably 1.2 to 2.0, and more preferably 1.3 to 1.9, when the protease is stored together with the peptide.

22. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20,
wherein the protease after storage (as described in example 2) has a residual activity increased by a factor of at least 1.1 to 2.5, preferably 1.2 to 2.0, and more preferably 1.3 to 1.9, when the protease is stored together with the peptide,
wherein the washing and cleaning agent is substantially free of boron-containing compounds, and preferably free of boron-containing compounds.

23. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20,
wherein the protease after storage (as described in example 2) has a residual activity increased by a factor of at least 1.1 to 2.5, preferably 1.2 to 2.0, and more preferably 1.3 to 1.9, when the protease is stored together with the peptide,
wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

24. A washing and cleaning agent, in particular, liquid washing and cleaning agent, and particularly preferably liquid textile washing agent, comprising
a) at least one protease which exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
b) at least one peptidic inhibitor which has an initial inhibitory power of at least 2.5 to 50, preferably 5 to 40, preferably 10 to 30, and more preferably 12.5 to 20,
wherein the protease after storage (as described in example 2) has a residual activity increased by a factor of at least 1.1 to 2.5, preferably 1.2 to 2.0, and more preferably 1.3 to 1.9, when the protease is stored together with the peptide,
wherein the washing and cleaning agent is substantially free of boron-containing compounds, and preferably free of boron-containing compounds, and
wherein the agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

25. The washing and cleaning agent according to one of points 1 to 24, wherein the washing and cleaning agent comprises at least one further enzyme, wherein the enzyme is selected from the group consisting of amylases, cellulases, hemicellulases, mannanases, tannases, xylanases, xanthanases, xyloglucanases, β-glucosidases, pectinases, carrageenases, perhydrolases, oxidases, oxidoreductases, lipases, proteases, and combinations thereof, preferably at least one amylase and/or at least one cellulase.

26. The washing and cleaning agent according to point 25, wherein the at least one further enzyme is an amylase, wherein the amylase has amylolytic activity and is selected from
a) an α-amylase which comprises an amino acid sequence which is at least 80%, 81%, 82%, 83%, 84%, 85%, 86%, 87%, 88%, 89%, 90%, 91%, 92%, 93%, 94%, 95%, 96%, 97%, 98%, or 99% identical to the amino acid sequence specified in SEQ ID NO:13 over the entire length thereof and optionally has at least one amino acid substitution at one of the positions 172, 202, 208, 255, and 261 in the numbering according to SEQ ID NO:13, preferably selected from the group consisting of M202L, M202V, M202S, M202T, M202I, M202Q, M202W, S255N, R172Q, and combinations thereof; and/or
b) an α-amylase comprising an amino acid sequence which is at least 60%, preferably at least 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 92%, 93%, 94%, 95%, 96%, 97%, 98%, or 99% identical to the amino acid sequence specified in SEQ ID NO:14 over the entire length thereof, and optionally has at least one amino acid substitution at one of positions 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484 and/or a deletion at one of positions 183 and 184 in the numbering according to SEQ ID NO:14, preferably at least one amino acid substitution at one of positions 9, 26, 149, 182, 186, 202, 257, 295, 299, 323, 339, and 345, and/or particularly preferably at least one amino acid substitution or deletion selected from the group consisting of R118K, D183*, G184*, N195F, R320K, R458K, and combinations thereof; and/or
c) an α-amylase comprising an amino acid sequence which is at least 65%, and increasingly preferably at least 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 92%, 93%, 94%, 95%, 96%, 97%, 98%, or 99% identical to the amino acid sequence specified in SEQ ID NO:15 over the entire length thereof, and optionally has at least one substitution and/or deletion at one of positions 93, 116, 118, 129, 133, 134, 140, 142, 146, 147, 149, 151, 152, 169, 174, 183, 184, 186, 189, 193, 195, 197, 198, 200, 203, 206, 210, 212, 213, 235, 243, 244, 260, 262, 284, 303, 304, 320, 338, 347, 359, 418, 431, 434, 439, 447, 458, 469, 476, and 477 in the numbering according to SEQ ID NO:15, preferably amino acid deletions at the positions 183 and 184; and/or
d) an α-amylase which comprises an amino acid sequence which is at least 89% and increasingly preferably at least 90%, 91%, 92%, 93%, 94%, 95%, 96%, 97%, 98%, or 99% identical to the amino acid sequence specified in SEQ ID NO:16 over the entire length thereof and has at least one deletion at one of the positions 180, 181, 182, 183, and 184 in the numbering according to SEQ ID NO:16, preferably deletions at at least two positions selected from the positions 180+181, 181+182, 182+183, and 183+184 in the numbering according to SEQ ID NO:16, and particularly preferably at the positions 183+184 in the numbering according to SEQ ID NO:16, and/or has at least one substitution at one of the positions 405, 421, 422, and 428 in the numbering according to SEQ ID NO:16, selected from the group consisting of I405L, A421H, A422P, A428T, and combinations thereof.

27. A use of a peptide for improving the stability, in particular the storage stability, of proteases in a washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptide has an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length,
wherein the washing and cleaning agent is substantially free of boron-containing compounds, and preferably free of boron-containing compounds, and
wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.,
preferably in a temperature range of about 20° C. to about 60° C., particularly preferably of about 20° C. to about 40° C., and most preferably at about 30° C.

28. A use of a peptide for improving the stability, in particular the storage stability, of proteases in a washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptide has an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, and
wherein the washing and cleaning agent is substantially free of boron-containing compounds, and preferably free of boron-containing compounds,
preferably in a temperature range of about 20° C. to about 60° C., particularly preferably of about 20° C. to about 40° C., and most preferably at about 30° C.

29. A use of a peptide for preventing and/or reducing the autoproteolysis of a protease contained in the washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptide has an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, and
wherein the washing and cleaning agent is substantially free of boron-containing compounds, and preferably free of boron-containing compounds,
wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

30. The use of a peptide for preventing and/or reducing the autoproteolysis of a protease contained in the washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptide has an amino acid sequence at least 90% and increasingly preferably at least 91%, 92%, 93%, 94%, 95%, 96%, 97%, 98%, 99%, or 100% identical to an amino acid sequence selected from the group consisting of SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, preferably from SEQ ID NO:2, SEQ ID NO:4, SEQ ID NO:5, SEQ ID NO:8, or SEQ ID NO:11, over its total length, and
wherein the washing and cleaning agent is substantially free of boron-containing compounds, and preferably free of boron-containing compounds, and
wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.,
preferably in a temperature range of about 20° C. to about 60° C., particularly preferably of about 20° C. to about 40° C., and most preferably at about 30° C.

31. A use of a peptidic inhibitor for improving the stability, in particular the storage stability, of proteases in a washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptidic inhibitor has an initial inhibitory power of at least 2.5 to 50, preferably 5 to 40, preferably 10 to 30, and more preferably 12.5 to 20,
wherein the washing and cleaning agent is substantially free of boron-containing compounds, and preferably free of boron-containing compounds, and
wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.,
preferably in a temperature range of about 20° C. to about 60° C., particularly preferably of about 20° C. to about 40° C., and most preferably at about 30° C.

32. The use of a peptide for improving the stability, in particular the storage stability, of proteases in a washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptidic inhibitor has an initial inhibitory power of at least 2.5 to 50, preferably 5 to 40, preferably 10 to 30, and more preferably 12.5 to 20, and
wherein the washing and cleaning agent is substantially free of boron-containing compounds, and preferably free of boron-containing compounds,
preferably in a temperature range of about 20° C. to about 60° C., particularly preferably of about 20° C. to about 40° C., and most preferably at about 30° C.

33. The use of a peptide for preventing and/or reducing the autoproteolysis of a protease contained in the washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptidic inhibitor has an initial inhibitory power of at least 2.5 to 50, preferably 5 to 40, preferably 10 to 30, and more preferably 12.5 to 20,
wherein the washing and cleaning agent is substantially free of boron-containing compounds, and preferably free of boron-containing compounds,
wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.

34. The use of a peptide for preventing and/or reducing the autoproteolysis of a protease contained in the washing and cleaning agent,
wherein the protease exhibits proteolytic activity and comprises an amino acid sequence which is at least 70% and increasingly preferably at least 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, and 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, preferably two, and more preferably three, of the positions that correspond to positions 6, 89, 131, 166, 189, 211, or 224, at least one additional amino acid substitution, selected from the group consisting of 6W/F, 89A/G, 131H/Y/F, 166M/L/I, 187D, 189T/L/I/R, 211N/Q, and 224A/G, preferably 6W, 89A, 131H, 166M, 187D, 189R, 189T, 211N, and 224A,
wherein the peptidic inhibitor has an initial inhibitory power of at least 2.5 to 50, preferably 5 to 40, preferably 10 to 30, and more preferably 12.5 to 20,
wherein the washing and cleaning agent is substantially free of boron-containing compounds, and preferably free of boron-containing compounds, and wherein the washing and cleaning agent has a pH in a range of approximately 6 to approximately 11, in particular of approximately 6.5 to approximately 10.5, more preferably of approximately 7 to approximately 10, and particularly preferably of approximately 8 to approximately 9, in a 1 wt. % solution in deionized water at 20° C.,
preferably in a temperature range of about 20° C. to about 60° C., particularly preferably of about 20° C. to about 40° C., and most preferably at about 30° C.

35. The use according to one of points 27 to 34, wherein the peptide leads to a residual activity of the protease that is increased by a factor of at least 1.1 to 2.5, preferably 1.2 to 2.0, and more preferably 1.3 to 1.9 (as described in example 2).

### EXAMPLES

### Example 1: Determination of the Activity of Proteases in the Presence of Peptidic Inhibitors

The activity of a protease according to the invention in the presence of peptidic inhibitors (PI) was determined in a commercially available washing agent matrix (Table 1) using a common protease activity assay.

TABLE 1
WASHING AGENT MATRICES USED

| | Wt. % of active | Wt. % of active substance | | | |
|---|---|---|---|---|---|
| | substance in the | in the formulation | | | |
| Chemical name | raw material | A | B | C | D |
| Demineralized water | 100 | up to 100 | | | |
| Defoamer | 100 | <1% | | | |
| Citric acid | 100 | 1-5% | | | |
| FAEOS | 70 | 3-8% | | | |
| FAEO | 100 | 2-11% | | | |
| LAS | 96 | 3-20% | | | |
| C₁₂₋₁₈ fatty acid, Na | 30 | 0.3-4% | | | |
| salt | | | | | |
| Monoethanolamine | 100 | 4-8% | | | |
| NaOH | 50 | 0.5-2% | | | |
| Glycerol | 99.5 | 1-3% | | | |
| 1,2-propanediol | 100 | 8-12% | | | |
| HEDP | 60 | 0.5-2% | | | |
| Soil repellent | 30 | 0.1-1% | | | |
| polymer | | | | | |
| Perfumes, DTI, | t.q. | Minors | | | |
| Enzymes (other than | | | | | |
| protease) | | | | | |
| Protease (as in | t.q. | 0.7 μmol | | | |
| example 1) | | | | | |
| 4-FPBA | 100 | 0% | 2% | 0% | 0% |
| PI 1 | t.q. | 0% | 0% | 13.2 μmol | 0% |
| PI 4 | t.q. | 0% | 0% | 0% | 19.6 μmol |

Dosage 3.17 g/L; pH 8.2-8.4

TABLE 2
PEPTIDIC INHIBITORS

| Peptidic inhibitor | Sequence |
|---|---|
| PI 1 | SEQ ID NO: 2 |
| PI 2 | SEQ ID NO: 3 |
| PI 3 | SEQ ID NO: 4 |
| PI 4 | SEQ ID NO: 5 |
| PI 5 | SEQ ID NO: 6 |
| PI 6 | SEQ ID NO: 7 |
| PI 7 | SEQ ID NO: 8 |
| PI 8 | SEQ ID NO: 9 |
| PI 9 | SEQ ID NO: 10 |
| PI 10 | SEQ ID NO: 11 |
| PI 11 | SEQ ID NO: 12 |

The activity of the protease is determined by releasing the chromophore para-nitroaniline from the substrate succinyl alanine-alanine-proline-phenylalanine-para-nitroanilide (AAPF-pNA; Bachem L-1400). The release of the pNA causes an increase in extinction at 410 nm, the time profile of which is a measure of the enzymatic activity.

The measurement was carried out at a temperature of 25° C., a pH of 8.6, and a wavelength of 410 nm. The measurement time was 15 h with a measurement interval of 3 minutes.

### Measurement Approach:

10 μL inhibitor (final concentration: 0.2 μg)
10 μL AAPF solution (final concentration: 1.25 μg)
10 μL diluted protease solution (final concentration: 0.014 U)
170 μL Tris/HCl (0.1 M, pH 8.6)

### Protease Used:

SEQ ID NO:1-P9T-N130D-Q271E-N144K-N252T-Y217M-T133A-S224A-S189T-S89A

The activity of the protease without inhibitor determined as described above was normalized to 100%, and the activity of the protease in the presence of the peptidic inhibitors was determined in relation to it.

TABLE 3
RESULTS OF THE ACTIVITY MEASUREMENT (DETERMINATION
OF THE INITIAL INHIBITORY POWER OF THE
PEPTIDIC INHIBITORS)

| Peptide inhibitor | Amount used (μmol) | Protease activity (%) |
|---|---|---|
| Without inhibitor | 0 | 100% |
| PI 1 | 13.2 | 40% |
| PI 2 | 13.2 | 20% |
| PI 3 | 13.1 | 8% |
| PI 4 | 19.6 | 8% |
| PI 5 | 19.6 | 5% |
| PI 6 | 20.1 | 7% |
| PI 7 | 19.4 | 5% |
| PI | 19.8 | 10% |
| PI 9 | 21.0 | 9% |
| PI 10 | 20.7 | 2% |
| PI 11 | 8.0 | 33% |

### Example 2: Determination of the Storage Stability of a Protease According to the Invention

The residual activity (i.e., activity after storage) of a protease according to the invention in the presence of peptidic inhibitors (PI) was determined in a commercially available washing agent matrix (Table 1) using a common protease activity assay.

The protease variant mentioned was stored in the washing agent matrix according to Table 1 at 30° C. for 4 weeks and at 40° C. for 1 week. The residual activity of the protease after storage was determined using the AAPF-pNA method.

The measurement was carried out at a temperature of 25° C., a pH of 8.6, and a wavelength of 410 nm. The measurement time was 5 min at a measuring interval of 20 to 60 seconds.

### Measurement Approach:

10 μL AAPF solution (70 mg/mL)
1000 μL Tris/HCl (0.1 M, pH 8.6 with 0.1% Brij 35)
10 μL diluted protease solution from washing agent matrix
Kinetics produced over 5 min at 25° C. (410 nm)

The protease activity determined as described above before storage (t=0) was normalized to 100%, and the activity of the protease after storage was determined in relation to this.

TABLE 4
RESULTS OF THE RESIDUAL ACTIVITY

| formula | 4 W, 30° C. | 1 W, 40° C. |
|---|---|---|
| A | 40% | 34% |
| B | 47% | 72% |
| C | 66% | 65% |
| D | 74% | 62% |

1. A washing and cleaning agent, comprising:
a) at least one protease in an amount of 0.0001 to 1 wt. %, relative to the total weight of the washing and cleaning agent,
b) at least one peptide, in a 0.5-, 1.0-, 1.5-, 2.0-, 2.5-, 3.0-, 3.5-, 4.0-, 4.5-, 5.0-, 10-, 15-, 18-, 20-, 25-, 27-, or 30-fold molar excess relative to the molarity of the protease used, wherein the peptide has a length of 50 to 200, 55 to 190, or 60 to 180, amino acid functional groups, and
c) at least one washing and cleaning agent ingredient, in an amount of 0.01 to 99.9 wt. %, relative to the total weight of the washing and cleaning agent.

2. The washing and cleaning agent according to claim 1, wherein the protease after storage (as described in example 2) has a residual activity increased by a factor of at least 1.1 to 2.5, 1.2 to 2.0, or 1.3 to 1.9, when the protease is stored together with the peptide.

3. The washing and cleaning agent according to claim 1, wherein the peptide has an initial inhibitory power of at least 2.5 to 50, 5 to 40, 10 to 30, or 12.5 to 20.

4. The washing and cleaning agent according to claim 1, wherein the peptide has an amino acid sequence at least 90%, 91%, 92%, 93%, 94%, 95%, 96%, 97%, 98%, 99%, or 100% identical to an amino acid sequence selected from the group consisting of: SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, over its total length.

5. The washing and cleaning agent according to claim 1, wherein the protease exhibits proteolytic activity and comprises an amino acid sequence which is at least 70%, 71%, 72%, 73%, 74%, 75%, 76%, 77%, 78%, 79%, 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, or 98% identical to the amino acid sequence given in SEQ ID NO:1 over its entire length, and, in each case based upon the numbering according to SEQ ID NO:1, has (i) at the positions that correspond to positions 9, 130, 133, 144, 217, 252, and 271, the amino acid substitutions 9T, 130D, 133A, 144K, 217M, 252T, and 271E, and (ii) at at least one, two, or three, of the positions that correspond to positions 6, 89, 131, 166, 189, 211, or 224, at least one additional amino acid substitution, selected from the group consisting of: 6W/F, 89A/G, 131H/Y/F, 166M/L/I, 187D, 189T/L/I/R, 211N/Q, and 224A/G.

6. The washing and cleaning agent according to claim 5, wherein the protease has one of the following amino acid substitution variants, in each case based upon the numbering according to SEQ ID NO:1:
(i) P9T-N130D-T133A-N144K-G166M-S189T-Y217M-N252T-Q271E;
(ii) P9T-N130D-T133A-N144K-G166M-S189T-Y217M-S224A-N252T-Q271E;
(iii) P9T-S89A-N130D-G131H-T133A-N144K-S189T-Y217M-S224A-N252T-Q271E;
(iv) Y6W-P9T-N130D-T133A-N144K-S189T-Y217M-S224A-N252T-Q271E;
(v) P9T-N130D-T133A-N144K-G166M-S211N-Y217M-N252T-Q271E;
(vi) P9T-S89A-N130D-T133A-N144K-S189T-Y217M-S224A-N252T-Q271E;
(vii) P9T-S89A-N130D-T133A-N144K-N187D-Y217M-S224A-N252T-Q271E;
(viii) P9T-S89A-N130D-T133A-N144K-S189R-Y217M-S224A-N252T-Q271E;
(ix) P9T-S89A-N130D-T133A-N144K-N187D-S189R-Y217M-S224A-N252T-Q271E.

7. The washing and cleaning agent according to claim 1, wherein the washing and cleaning agent comprises at least one further enzyme, wherein the enzyme is selected from the group consisting of: amylases, cellulases, hemicellulases, mannanases, tannases, xylanases, xanthanases, xyloglucanases, β-glucosidases, pectinases, carrageenases, perhydrolases, oxidases, oxidoreductases, lipases, proteases, and combinations thereof.

8. The washing and cleaning agent according to claim 1, wherein the washing and cleaning agent ingredient is selected from the group consisting of: surfactants, builders, complexing agents, polymers, glass corrosion inhibitors, corrosion inhibitors, bleaching agents such as peroxygen compounds, bleach activators or bleach catalysts, water-miscible organic solvents, enzyme stabilizers, sequestering agents, electrolytes, pH regulators, and/or other auxiliaries such as optical brighteners, graying inhibitors, dye transfer inhibitors, foam regulators, and dyes and fragrances and combinations thereof.

9. The washing and cleaning agent according to claim 1, wherein the washing and cleaning agent is substantially free of boron-containing compounds or free of boron-containing compounds.

10. The washing and cleaning agent according to claim 1, wherein it has a pH in a range of approximately 9 to approximately 11, of approximately 6.5 to approximately 10.5, of approximately 10 to approximately 10, or of approximately pH 10, in a 1 wt. % solution in deionized water at 20° C.

11. A method for cleaning textiles and/or hard surfaces comprising:
using a washing or cleaning agent according to claim 1 in at least one method step, the method being carried out in a temperature range of about 20° C. to about 60° C., of about 20° C. to about 40° C., or of about 30° C.

12. A use of a washing or cleaning agent according to claim 1 for cleaning textiles and/or hard surfaces, in a temperature range of about 20° C. to about 60° C., of about 20° C. to about 40° C., or of about 30° C.

13. A use of a peptide for improving the stability, or the storage stability, of proteases in a washing and cleaning agent according to claim 1, wherein the peptide has an amino acid sequence which is at least 90%, or at least 91%, 92%, 93%, 94%, 95%, 96%, 97%, 98%, 99%, or 100% identical to an amino acid sequence selected from the group consisting of: SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12, over its total length, in a temperature range of: about 20° C. to about 60° C., about 20° C. to about 40° C., or at about 30° C.

14. The use according to claim 13, wherein the peptide leads to a residual activity of the protease that is increased by a factor of at least 1.1 to 2.5, 1.2 to 2.0, or 1.3 to 1.9 (as described in example 2).

15. A use of a peptide for preventing and/or reducing the autoproteolysis of a protease contained in the washing and cleaning agent, wherein the washing and cleaning agent is a washing and cleaning agent according to claim 1, wherein the peptide has an amino acid sequence which is at least 90%, 91%, 92%, 93%, 94%, 95%, 96%, 97%, 98%, 99%, or 100% identical to an amino acid sequence selected from the group consisting of: SEQ ID NO:2, SEQ ID NO:3, SEQ ID NO:4, SEQ ID NO:5, SEQ ID NO:6, SEQ ID NO:7, SEQ ID NO:8, SEQ ID NO:9, SEQ ID NO:10, and SEQ ID NO:11 and SEQ ID NO:12 over its total length.

16. (canceled)

17. A washing and cleaning agent, comprising:
a) at least one protease, preferably in an amount of 0.0001 to 1 wt. %, relative to the total weight of the washing and cleaning agent,
b) at least one peptide, in a 15-, 18-, 20-, 25-, or 27-fold molar excess relative to the molarity of the protease used, wherein the peptide has a length of 50 to 200, or 55 to 190, or 60 to 180, amino acid functional groups, and
c) at least one washing and cleaning agent ingredient, in an amount of 0.01 to 99.9 wt. %, relative to the total weight of the washing and cleaning agent.
